(19) United States
(12) Patent Application Publication
(10) Pub. No.: US 2009/0113116 A1
(43) Pub. Date: Apr. 30, 2009

(54) Digital content kiosk and methods for use therewith

(76) Inventors: E. Earle Thompson, Livermore, CA (US); Roy E. Scheuerlein, Cupertino, CA (US); Thomas N. Toombs, Los Gatos, CA (US); Ron Barzilai, Kfar Veradim (IL); Manish Bhatia, Cupertino, CA (US)

Correspondence Address: BRINKS HOFER GILSON & LIONE/SanDisk, P.O. BOX 10395, CHICAGO, IL, 60610, US

(21) Appl. No.: 11/978,977

(22) Filed: Oct. 30, 2007

(51) Int. Cl. G06F 12/02

(52) U.S. Cl. 711/103; 711/E12.008

(57) ABSTRACT

A digital content kiosk and methods for use therewith are disclosed. Various embodiments are disclosed relating to exemplary memory devices, memory architectures, and programming techniques that can be used with a digital content kiosk, exemplary mechanical and electrical components of a digital content kiosk, exemplary security aspects of a digital content kiosk, and exemplary uses of a digital content kiosk. Other embodiments are disclosed, and each of these embodiments can be used alone or in combination with one another.

### BACKGROUND

DVDs are currently popular media for distributing video content to users. DVDs are typically programmed with video content at a factory and shipped to a retail store or warehouse for sale to the public. Because a retail store or warehouse needs to stock a relatively large number of DVDs to ensure that a desired title is available for purchase, the retail store or warehouse needs to dedicate a relatively large amount of floor space for DVD storage racks and bins. While recordable DVDs are available, retail stores have not used recordable DVDs to program video content “on-the-fly” as an alternative to stocking factory-programmed DVDs. Recordable DVDs are generally more expensive than factory-programmed DVDs, and programming a recordable DVD with DVD-quality and length video content can require a relatively long amount of time. Also, without the proper security in place, video content owners may not want to authorize retail stores to locally-load video content because of the risk that an employee at a retail store could make unauthorized copies. Accordingly, recordable DVDs are primarily used today by end-users to store video content from home electronic devices.

Instead of purchasing a factory-programmed DVD from a retail store or warehouse, a consumer can rent a factory-programmed DVD from kiosks at locations such as convenience stores and apartment complexes. These kiosks do not program DVDs with video content but rather merely store some limited number of factory-programmed DVDs for rental. Since these kiosks only store a limited number of DVDs, a kiosk may not carry a video title desired by a user. Even if the kiosk carries the video title, the kiosk may not have a copy of that title available when a user wants to rent it.

### BRIEF DESCRIPTION OF THE DRAWINGS

FIGS. 1a and 1b are front and rear perspective views, respectively, of a video kiosk of an embodiment.

FIG. 2 is an illustration of a key pad of a video kiosk of an embodiment.

FIG. 3 is an illustration of a memory device of an embodiment comprising a relatively high-speed programming port and a relatively low-speed user port.

FIG. 4 is an illustration of a memory device of an embodiment comprising a dual-use port.

FIG. 5 is an illustration of a memory device of an embodiment comprising an interim package and an outer package shell.

FIG. 6 is a more-detailed illustration of the memory device of FIG. 5.

FIG. 7 is an illustration of a non-volatile memory integrated circuit of a memory device of an embodiment.

FIG. 8 is an illustration of memory array and associated circuitry of an embodiment.

FIG. 9 is a diagrammatic illustration of some of the internal components of a video kiosk of an embodiment.

FIGS. 10a and 10b are top and rear views, respectively, of a transport mechanism of a video kiosk of an embodiment.

FIGS. 11a, 11b, and 11c are front, top, and side views, respectively, of an arm and pickup head of a video kiosk of an embodiment.

FIGS. 12a and 12b are top and side views, respectively, of a tray of interim packages of an embodiment.

FIGS. 13a, 13b, 13c, and 13d are top, side, rear, and front views, respectively, of an interim package of an embodiment.

FIGS. 14a, 14b, 14c, and 14d are top, side, rear, and front views, respectively, of a final package shell of an embodiment.

FIG. 14e is a section view of the final package shell of FIGS. 14a, 14b, 14c, and 14d assembled onto the interim package of FIGS. 13a, 13b, 13c, and 13d.

FIGS. 15a, 15b, and 15c are top, rear, and front views, respectively, of a final package shell of an embodiment.

FIGS. 15d and 15e are section and side views, respectively, of the final package shell of FIGS. 15a, 15b, and 15c assembled onto the interim package of FIGS. 13a, 13b, 13c, and 13d.

FIGS. 16a, 16b, and 16c top, side, and section views, respectively, of an interim package of an embodiment.

FIGS. 17a, 17b, and 17c are side, bottom, and top views, respectively, of the interim package of FIGS. 16a, 16b, and 16c combined with a final package shell of an embodiment.

FIGS. 18a and 18b are side and top views, respectively, of a programming station of a video kiosk of an embodiment.

FIG. 19 is a side view of a final package station of a video kiosk of an embodiment.

FIG. 20 is a side view of a label station of a video kiosk of an embodiment.

FIG. 21 is a diagrammatic illustration of a side view of a video kiosk of an embodiment.

FIGS. 22a and 22b are illustrations of security aspects of a video kiosk environment of an embodiment.

FIG. 23 is an illustration of various components of a video kiosk of an embodiment.

FIGS. 24a, 24b, 24c, and 24d are illustrations of programming a memory device of an embodiment.

FIG. 25 is an illustration of a programming error in a memory device of an embodiment.

FIG. 26 is an illustration of a memory device of an embodiment.

### DETAILED DESCRIPTION OF THE PRESENTLY PREFERRED EMBODIMENTS

### Introduction

By way of introduction, the embodiments described below provide a digital content kiosk for on-the-fly programming of digital content onto a removable solid-state memory device. “Digital content” can take any suitable form, such as, but not limited to, video (with or without accompanying audio) (e.g., a movie, an episode of a TV show, a news program, etc.), audio (e.g., a song, a podcast, one or a series of sounds, etc.), still or moving images (e.g., a photograph, a computer-generated display, etc.), text (with or without graphics) (e.g., an article, a text file, etc.), a game, and a hybrid multi-media presentation of two or more of these forms. In the following examples, “digital content” takes the form of video content, and the “digital content kiosk” takes the form of a video kiosk. It should be noted that these are merely examples and other forms of digital content can be used. Accordingly, no specific form of digital content should be read into the claims unless explicitly recited therein.

There are several advantages associated with a video kiosk that provides on-the-fly programming of video content onto a removable solid-state memory device. First, a retail store can use one or more kiosks to replace its DVD storage racks and bins, thereby effectively creating additional floor space for the retail store to display other merchandise. In addition to becoming a practical replacement for DVD storage racks and bins in a retail store, a video kiosk can be used to sell video content in new markets, such as locations that do not have the floor space needed for DVD storage racks and bins. Similar to franchised ATMs, a video kiosk can be located in almost any location, including airports, convenience stores, and even movie theatres, where a kiosk can offer movie-goers a take-home version of a movie they just watched. Further, a video kiosk can almost entirely eliminate distribution channel costs for a video content owner, as, from a studio's perspective, the distribution cost would be similar to a pay-per-view system. Additionally, because a video kiosk programs video content on-the-fly, there is no risk of a video title being out of stock, as there currently is with retail stores and with kiosks that rent factory-programmed DVDs.

While the video kiosk can use any type of media, it is presently preferred that the video kiosk use a removable solid-state memory device, as solid-state memory devices are generally more portable and not as fragile as optical, magnetic, and other types of media. This is especially important in today's mobile environment where consumers want to be able to watch video content whenever and wherever they want. Although a removable solid-state memory device with suitable memory capacity is currently more expensive than a DVD, the additional cost is outweighed by the above-mentioned advantages (e.g., floor space gained by retailers, revenue generated by franchising into new markets, and distribution cost savings to video content owners). Additionally, as the price of solid-state memory devices continues to decrease, a solid-state-memory-device-based video kiosk solution becomes more and more financially attractive. As another advantage, players for solid-state memory devices can be less-expensive, smaller, and more portable than players for DVDs or other rotating media. This is especially true when a solid-state memory device contains a built-in digital decoder, in which case the player can contain a simple, inexpensive processor and a connector to a display device. As yet another advantage, solid-state memory devices can offer net-based DRM solutions that are not suitable for DVDs.

Solid-state memory devices also offer a fresh alternative to the DVD-saturated video market. Many consumers see next generation DVDs (HD DVD or BluRay) as nothing more than a glorified version of a regular DVD that costs twice as much. Many consumers are looking for something different from what they already have, and solid-state memory devices that store movie-quality and length videos are as revolutionary over DVDs as DVDs were over videocassettes. As studios, retailers, and consumers fully appreciate the advantages described above, solid-state memory devices can gain in popularity to the point of replacing DVDs as the predominant media for home video content, and video kiosks can be the preferred mechanisms for distributing such devices.

Video Kiosk Overview

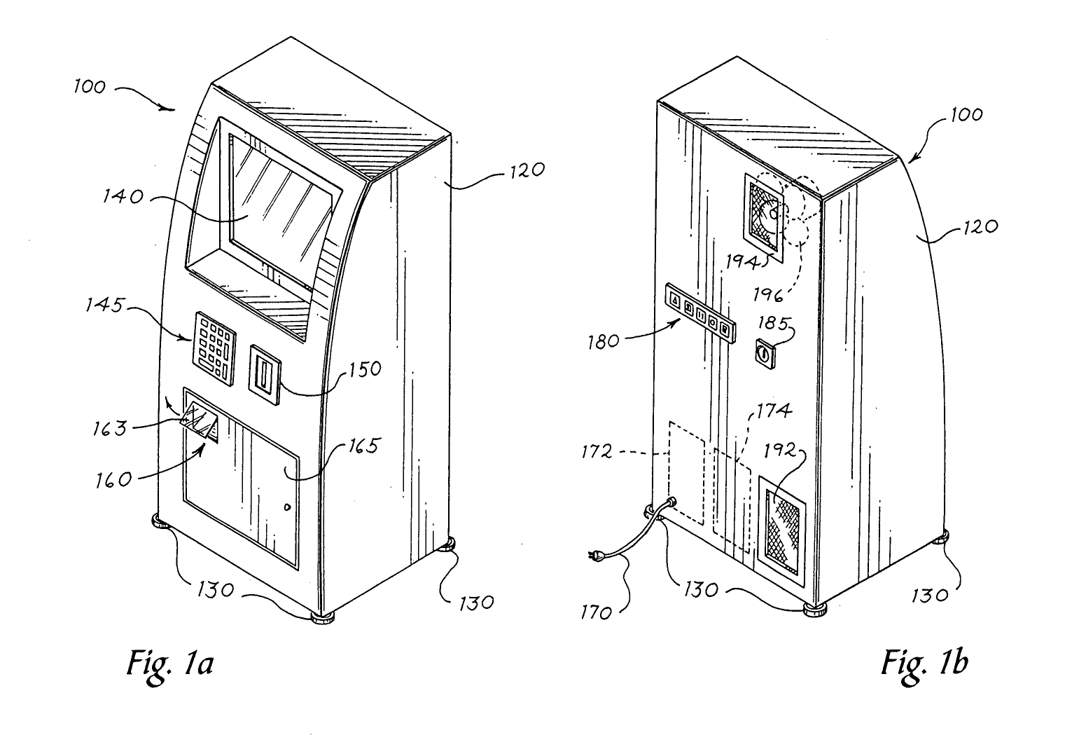

Turning now to the drawings, FIGS. 1a and 1b are front and rear perspective views, respectively, of a video kiosk 100 of an embodiment. It should be noted that the various components shown in these and other figures are merely for illustration purposes and should not be read into the claims unless explicitly recited therein. A “video kiosk” refers to a device that (1) houses various electrical and/or mechanical components used to program video content into a removable memory device and (2) is designed to be located in a relatively-accessible location (e.g., in a store, in an airport, on the street, etc.) for relatively public use, as compared to a device designed to be located in an individual's home for personal use. As used herein, “video content” generally refers to a series of moving images (with or without accompanying audio), which can be stored and transferred as a video file. As also used herein, a “solid-state memory device” refers to a memory device that uses a solid-state memory array to store data. A “removable” solid-state memory device is a solid-state memory device that is easily portable and can easily be connected to/disconnected from a mating device, such as a media player or card reader. A solid-state memory device can take any suitable form, can use any suitable type of memory array (e.g., write-many or one-time programmable, two-dimensional or three-dimensional, etc.), and can be made from any suitable material. It should be noted that, depending on the context, the term “memory device” can refer to the device being processed by the video kiosk 100 or to the final device delivered to the user. In some situations, the memory device being processed by the video kiosk 100 is the same shape and size as the physical device that is delivered to the user. In other situations, the memory device being processed by the video kiosk 100 is an “interim” memory device that is later combined with an outer (or final) package shell for delivery to the user. A memory device may also be referred to herein as a “media device” or simply “media.”

While it is presently preferred that the video kiosks of these embodiment be used with solid-state memory devices, a video kiosk can be altered to use other types of devices, such as, but not limited to, optical and magnetic memory devices. Also, it should be noted that the video kiosk 100 can be used exclusively to provide video content or can additionally be used to provide audio and other content, as well as provide information and other services. For example, in addition to providing video content, the video kiosk 100 can be used as an ATM, to access the Internet, to download songs, to provide directions, to print photos from a memory card, and to print movie or other types of tickets.

As shown in FIGS. 1a and 1b, the video kiosk 100 of this embodiment comprises a housing 120 that houses various electrical and mechanical components, which will be described in more detail below. The housing 120 also comprises a plurality of feet 130 to provide the video kiosk 100 with stability. Instead of having feet 130, the housing 120 can have rollers to provide the video kiosk 100 with mobility, or the video kiosk 100 can be mounted to a wall or built into another device. The video kiosk 100 also comprises a display device 140 to display video selection choices and other information to a user. In one embodiment, the display device 140 is preferably capable of SVGA and higher resolution. The video kiosk 100 can also comprise a speaker or a headphone jack (not shown) to provide audio information to the user. Preferably, the display device 140 takes the form of a touch-screen device, so a user simply touches choices displayed on the display device 140 to make a selection.

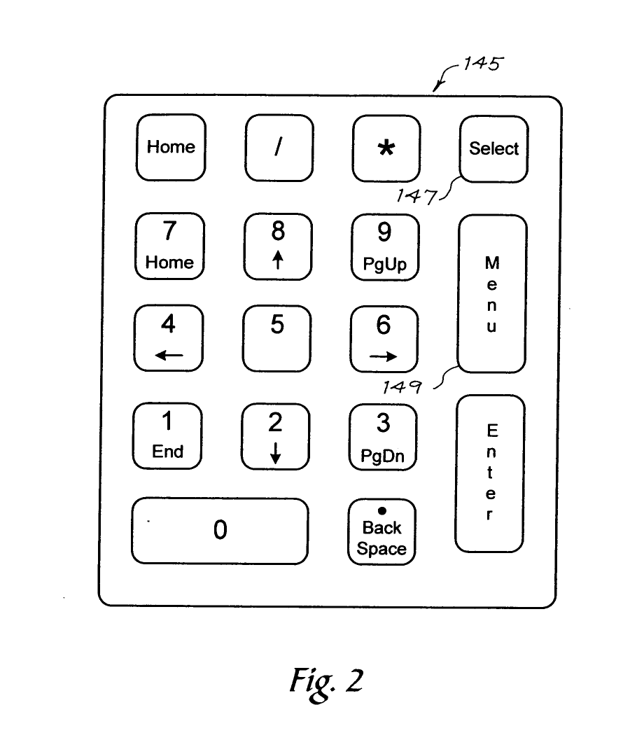

The video kiosk 100 can optionally contain a key pad 145 to accept user input if the touch-screen function is unavailable. FIG. 2 shows the key pad 145 in more detail. As shown in FIG. 2, the key pad 145 can take the form of a numeric input pad familiar to computer keyboard users but modified to include “select” and “menu” keys 147, 149. A user can use the arrow keys for screen navigation of a cursor (or a selected icon) and the Home, End, PgUp, and PgDn keys for rapid navigation on long displayed lists. The user can use the select key 147 to select an item indicated by the cursor/icon. In this way, the select key 147 functions as a “mouse click,” thereby allowing the key pad 145 to mimic familiar mouse control without a mouse. The menu key 149 can give cursor-location-sensitive menu options that display on the display device 140. The other keys of the key pad 145 can be used for fast and convenient numeric entry (e.g., for PIN entry, for account number entry, etc.). Instead of or in addition to a key pad, the video kiosk 100 can comprise a trackball, mouse, keyboard, remote control, or any other type of input device that allows a user to interact with the video kiosk 100.

Returning to FIGS. 1a and 1b, the video kiosk 100 in this embodiment also comprises a payment input device 150, which can take the form of a credit card (or gift, debit, or other type of card) reader, a coin slot, and/or a bill slot. The payment input device 150 allows a user to purchase video content from the video kiosk 100. Instead of or in addition to using the payment input device 150 to purchase video content, video content can be purchased from the video kiosk 100 using an account (e.g., one a user funds on-line). The video kiosk 100 can also comprise a printer (not shown) to print a transaction receipt for a customer.

The video kiosk 100 further comprises a memory device delivery location, which in this embodiment, is a memory device output chute 160 accessed by a user by lifting a transparent, swinging door 163. In this embodiment, the swinging door 163 is part of a locked, removable panel 165 that provides service access to trays of memory devices stored in the video kiosk 100. In this embodiment, the video kiosk 100 stores memory devices and provides a user with one of those memory devices after the video kiosk 100 programs video content onto the memory device. In this way, the video kiosk 100 both programs and dispenses a memory device to a user. Instead of or in addition to dispensing a memory device to a user, the video kiosk 100 can include a memory device input port to allow a user to provide his own memory device to the video kiosk 100 for programming. However, there are several advantages associated with the video kiosk 100 dispensing a programmed memory device. For example, in some embodiments, the video kiosk 100 programs video content into a somewhat specialized memory device (e.g., a memory device with both a high-speed programming port and a conventional user port). If a user does not have such a memory device and if such a memory device is not readily available to the user when he wants to use the video kiosk 100 (e.g., if the video kiosk 100 is not located near a facility that sells such a memory device), the user would not be able to use the video kiosk 100. This problem is eliminated if the video kiosk 100 has its own supply of memory devices that can be programmed and dispensed to a user. Additionally, as described in more detail below, the video kiosk 100 can store a variety of different-shaped outer package shells and customize a programmed memory device to fit into the type of player owned by the user.

Turning now to FIG. 1b, the rear of the video kiosk 100 comprises a power cord 170, which supplies voltage from an electrical outlet to a battery-backed-up voltage supply 172 and voltage regulator 174 internal to the video kiosk 100. The battery-backed-up voltage supply 172 preferably has sufficient capacity to allow the video kiosk 100 to complete a video programming transaction and cycle the internal electronics to a powered-down state in event of a power loss. The voltage regulator 174 regulates the voltage from an electrical outlet to a suitable level for the internal electronics of the video kiosk 100. The rear of the video kiosk 100 also comprises a plurality of ports 180 to connect a PC-based control system of the video kiosk 100 to external computers, networks (e.g., the Internet), and/or peripherals. These ports 180 can include, but are not limited to, one or more of the following: an Ethernet port, a telephone line jack, a coaxial cable connector, a USB port, a serial port, and a parallel port. Through one or more of these ports 80, the video kiosk 100 can connect to an external network location to retrieve video content on-the-fly when requested by a user or to retrieve video content for local storage on one or more mass storage devices in the video kiosk 100. A variety of ports are preferred so that the video kiosk 100 can connect to the network regardless of the type of connection available at the physical location of the video kiosk 100. The plurality of ports 180 can also have a connection for a service technician to connect a laptop computer or other device for servicing the video kiosk 100 and/or to locally-load video content. Next to the plurality of ports 180 is a system reset key switch 185, which allows a service technician to insert and turn a key to reset the PC-based control system of the video kiosk 100. The rear of the video kiosk 100 also comprises an air intake vent 192, an air exhaust vent 194, and a fan 196 to provide air circulation to help cool the internal components of the video kiosk 100 (and, as described below, to cool a memory device as it is being programmed by the video kiosk 100).

The video kiosk 100 also comprises circuitry to control the operation of its various electrical and electromechanical components. A memory device used by the video kiosk 100 can also comprise its own circuitry for controlling programming and other functions in the memory device. As used herein, the term “circuitry” (or “circuit”) can include one or more components and be a pure hardware implementation and/or a combined hardware/software (or firmware) implementation. Accordingly, “circuitry” can take the form of one or more of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example.

In operation, the video kiosk 100 receives a selection of video content either manually from a user using the touch-screen display 140 and/or the key pad 145 or automatically by a software agent in the video kiosk 100 (e.g., based on the user's past selections) (see, for example, U.S. patent application Ser. No. 09/823,489, filed Mar. 30, 2001, which is hereby incorporated by reference). The selected video content can be stored in one or more mass storage devices in the video kiosk 100 or retrieved from an external location on-the-fly. The video kiosk 100 establishes communication with a removable solid-state memory device (e.g., by sending various signals to the memory device after programming pins of the memory device are manually or automatically mated with programming pins in the video kiosk 100) and then programs the selected video content into a solid-state memory array in the memory device, which is ultimately provided to the user.

The next several sections present various embodiments of (1) exemplary memory devices, memory architectures, and programming techniques that can be used with the video kiosk 100, (2) exemplary mechanical and electrical components of the video kiosk 100, (3) exemplary security aspects of the video kiosk 100, and (4) exemplary uses of the video kiosk 100. It should be understood that these various embodiments can be used alone or in combination with one another.

### Exemplary Memory Devices, Architectures, and Programming Techniques

In many environments, the video kiosk 100 would be used to program relatively large video files of relatively high-resolution content (e.g., a standard or high definition movie). In situations where a consumer waits in front of the video kiosk 100 as the programming occurs, it may be preferred to have the programming occur in a timely fashion (e.g., in a matter of a few minutes (or less) instead of tens of minutes) to avoid the consumer becoming impatient. Unfortunately, the ports of many conventional portable, solid-state memory devices cannot handle the desired programming bandwidth. (As used herein, a “port” refers to an interface between one component and another, external component and, in these embodiments, often takes the form of a collection of pins.) For example, many portable solid-state memory devices use an SD (or CompactFlash, etc.) port which is relatively easy to drive by portable consumer electronics products (e.g., media players, digital cameras, etc.). However, the programming rate associated with such a port can be in the range of 5 MB/sec to 20 MB/sec, which may be too slow for a video kiosk environment. For example, at a data rate of 20 MB/sec, programming a 20 GB video file can take almost 20 minutes, which may be too long for a consumer to wait in front of the video kiosk 100.

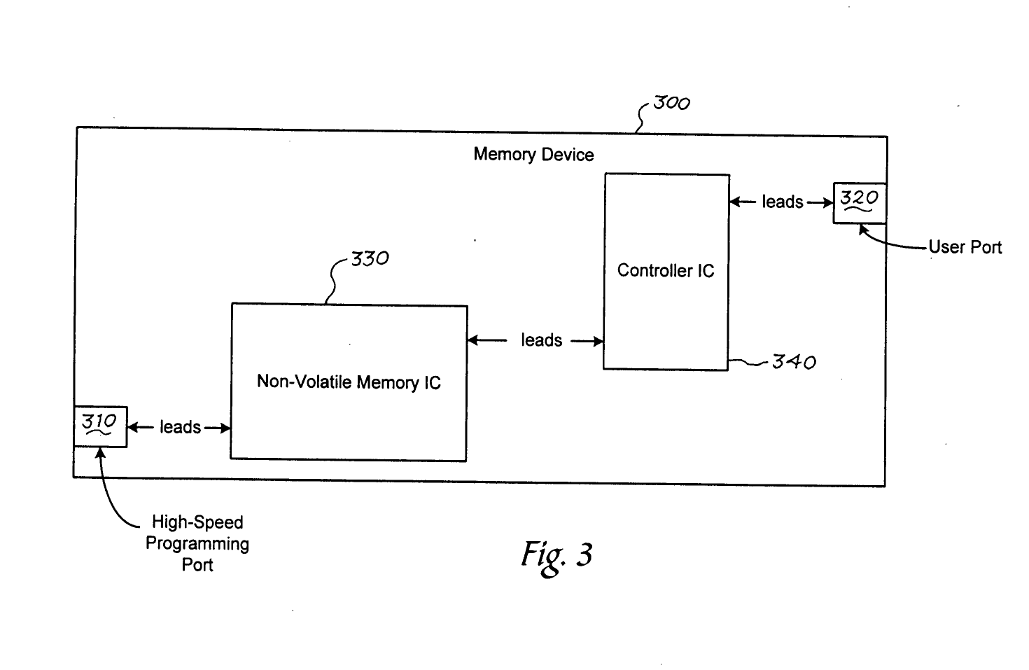

To address this problem, the memory device 300 shown in FIG. 3 comprises two ports: a relatively high-speed programming port 310 directly connected to a non-volatile memory integrated circuit (IC) 330 and a relatively low-speed user port 320 indirectly connected to the non-volatile memory IC 330 via a controller IC 340. The terms “relatively high speed” and “relatively low speed” refers to one port's speed with respect to the other, and the speeds of the ports 310, 320 can be designed to provide any suitable data rate. For example, in one embodiment, the user port 320 takes the form of an SD port with a data transfer rate in the range of 5 MB/sec to 20 MB/sec. Although this data rate may be deemed too slow for programming video content in the video kiosk 100, this data rate may be perfectly acceptable when the video content is later played from the memory device 300. On the other hand, the high-speed programming port 310 has a data transfer rate of preferably greater than about 65 MB/sec, more preferably greater than about 200 MB/sec, and even more preferably of about 500 MB/sec. At these data rates, programming a 20 GB video file would take about five minutes, about one-and-three-quarters minutes, and 40 seconds, respectively.

Because the memory device 300 has two types of ports, the memory device 300 can provide “the best of both worlds”: the relatively high-speed programming port 310 can have the complexity needed for the video kiosk 100 to program the non-volatile memory IC 330 at a sufficiently fast rate, while the user port 320 can be a relatively simple and easy to drive port that is compatible with many conventional consumer electronics devices. In contrast, if the relatively high-speed port were used both as a programming port and a user port, there may be compatibility issues with conventional consumer electronics devices, as the high-speed port may be a specialized port that is incompatible with conventional ports commonly-used with consumer electronics devices. This incompatibility may cause the user to be less likely to use a video kiosk that if the memory device were easily used with his electronic equipment.

In a presently preferred embodiment, the high-speed programming port 310 takes the form of a DDR2 interface or a PCI Express interface. A DDR2 interface refers to a double-data-rate two synchronous dynamic random access memory interface, which has the ability to run its bus at twice the speed of the clock input of the port. In general, DDR2 stores data in memory cells on both the rising and falling edge of a clock. With DDR2, the bus can be, for example, 16 lines in parallel, so four bytes, each containing eight bits of data, can be transferred per clock cycle. Further information about DDR2 can be found in “DDR2 SDRAM Interfaces for Next-Gen Systems,” Electronic Engineering Times-Asia, Oct. 16-31, 2006, which is hereby incorporated by reference. A PCI Express interface is an interface technology that uses serial links known as “lanes.” Each lane carries a bandwidth of about 250 MB/sec. Technical specifications and other information about PCI Express can be obtained from PCI-Sig in Beaverton, Oreg. As another alternative, a DDR, Firewire, or Rambus interface can be used.

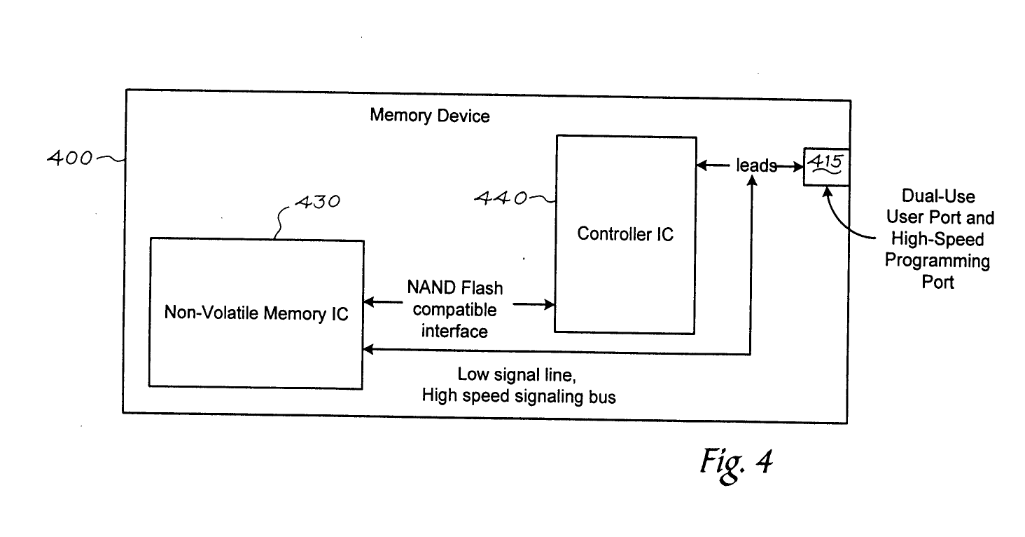

In the memory device 300 shown in FIG. 3, the relatively high-speed programming port 310 and the user port 320 are two different physical ports on the memory device 300. In an alternate embodiment shown in FIG. 4, the relatively high-speed port and the relatively low-speed port are integrated in a dual-use port 415. In this way, the same port 415 is used both for relatively high-speed programming and for relatively low-speed reading (and, optionally, for later programming). The dual-use port 415 is connected to the non-volatile memory IC 420 though a low signal line, high-speed signaling bus, which comprises pairs of lines using low-voltage differential signals (“LVDS”) for very high data rates. LVDS is a differential signaling system, which means that it transmits two different voltages that are compared at a receiver in the non-volatile memory IC 430. The difference in voltage is used to encode information. That is, the transmitter injects a small current (e.g., nominally 3.5 mA) into one wire or the other, depending on the logic level to be sent. The current passes through a load resistance on the non-volatile memory IC 430, where a receiver circuit senses the polarity of the voltage to determine the logic level. Each pair of wires can transfer data at 250 MB/sec or more. In one embodiment, two pairs are used to transfer data to the non-volatile memory IC 430 at about 500 MB/sec. In this embodiment, an explicit clock is not used; rather, the clock is recovered from the data stream via encoding called “8b/10b.” This coding ensures that there is a sufficient number of transitions with a single character (of 10 bits) to properly and reliably recover the clock. Four signal wires plus grounding lines are used at the dual-use port 415. In one embodiment, the signaling conventions on the high-speed bus are compatible with PCI Express standards.

Signals from the programming logic in the video kiosk 100 can indicate to the non-volatile memory IC 430 and the controller IC 440 which of those ICs is using the bus. In particular, the video kiosk 100 can send the controller IC 440 a command that forces it to send a command to the non-volatile memory IC 430 (over NAND Flash compatible interface) to activate the non-volatile memory IC's high-speed inputs circuits. The controller IC 440 can watch for a response from the non-volatile memory IC 430 that indicates that the high-speed data transfer is complete, that a high-speed programming operation is complete, or that an error has occurred. (In the case of an error, a signal can be sent to the programming control logic in the video kiosk 100 to interrupt high-speed data transfer.) When such a response is received, the dual-use port 415 is returned to normal interface with the controller IC 440.

Returning now to FIGS. 3 and 4, each of the memory devices 300, 400 in those figures was designed so that its external physical form (its packaging enclosure or “outer (or final) package shell”) exposes the port used for high-speed programming (i.e., the high-speed programming port 310 in the memory device 300 in FIG. 3 and the dual-use port 415 in the memory device 400 in FIG. 4). (The outer package shell of the memory device 300 of FIG. 3 also exposes the user port 320.) Accordingly, when the memory device 300, 400 is delivered to the user, the port used for high-speed programming will be accessible by the user. In this way, if the video kiosk 100 only partially fills the memory device 300, 400 with video content, the user can re-insert the memory device 300, 400 into the video kiosk 100 (or another video kiosk or device with a mating high-speed programming port) to program the memory device 300, 400 with additional video or other content. As another example, if encrypted video content is programmed into the memory device 300, 400 without associated decryption keys, the user can re-insert the memory device 300, 400 into the video kiosk 100 (or another video kiosk or device with a mating high-speed programming port) to program the memory device 300, 400 with the needed keys.

While allowing the high-speed programming port to be accessible by the user provides advantages, for safety, security, or simply aesthetic purposes, it may be desired to impede access to the relatively high-speed port 310 prior to providing the memory device 300 in FIG. 3 to the user. (Since the dual-use port 415 in the memory device 400 in FIG. 4 is used both as a high-speed programming port and as a user port, it may be difficult or impossible to alter the dual-use port 415 in such a way to impede access to the relatively high-speed port while retaining access to the user port.) In order to impede access to the relatively high-speed port 310, the video kiosk 100 can spray the pins of the port 310 with non-conductive ink (e.g., the same ink used to print the video title on the memory device 300, as will be described below) or can place a label or some other type of physical barrier over one or more of the pins.

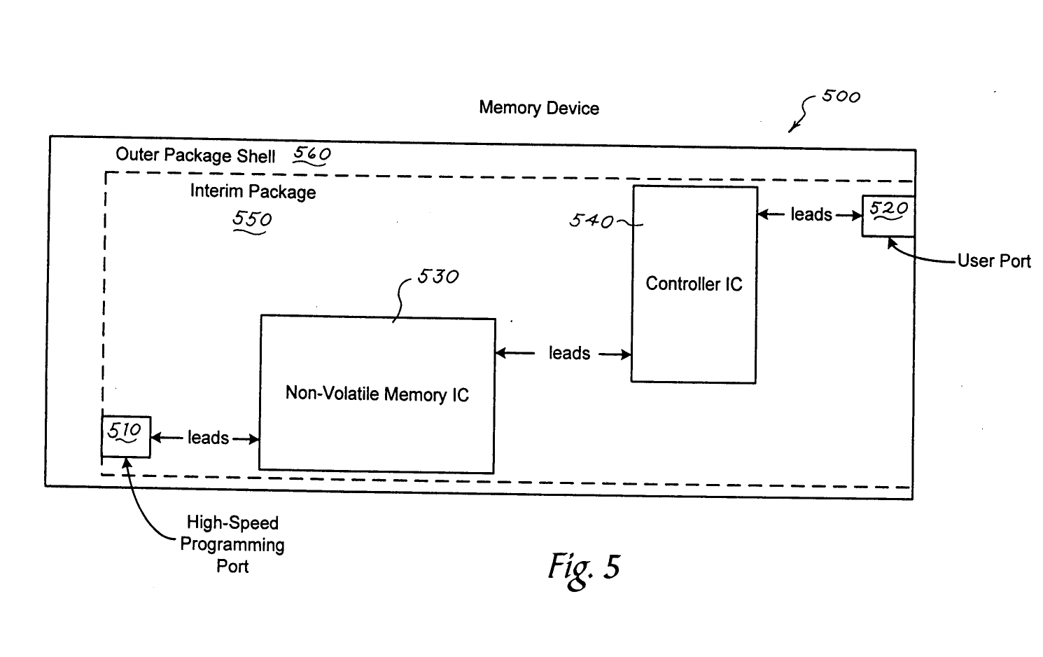

As an alternate way of impeding access to a relatively high-speed programming port, the relatively high-speed programming port can be exposed on an interim package that, after programming by the video kiosk 100, is combined with a final or outer package shell that covers the relatively high-speed programming port. This alternative is shown in FIG. 5. As shown in FIG. 5, the memory device 500 that is delivered to the user is a combination of two parts: (1) an interim package 550 that comprises the solid-state memory array (in the non-volatile memory IC 530), the relatively high-speed programming port 510, and the relatively low-speed user port 520 and (2) an outer package shell 560 that exposes the user port 520, but not the high-speed programming port 510, in the final memory device 500. In operation, the video kiosk 100 programs video content into the memory array of the interim package 550, and, when programming is complete, the video kiosk 100 combines the interim package 550 with the outer package shell 560 and delivers the resulting memory device 500 to the user. (The following section describes the mechanical and electrical components in the video kiosk 100 that can be used in those operations.)

The use of an outer package shell 560 provides advantages in addition to just concealing the high-speed programming port 510 for aesthetic and other reasons. For example, by stocking a variety of different types and shapes of outer package shells (in addition to or instead of stocking memory devices with a dual-use port), the user or video kiosk 100 can select the appropriate outer package shell based on the user's memory device player. For example, the video kiosk 100 can enclose an interim package in an SD™ outer package shell if the user has a player that uses SD™ cards, while the video kiosk 100 can enclose an interim package in a Memory Stick™ outer package shell if the user has a player that uses Memory Sticks™. As noted above, this ability to customize an outer package provides an advantage over embodiments in which a user supplies his own memory device to the video kiosk for programming.

Several alternatives can be used. For example, an outer package shell can be designed to provide the form factor versatility described above without covering the high-speed programming port of the interim package. As another example, while the design of the outer package shell in FIG. 5 allows the user port 520 of the interim package 520 to be the user port of the final memory device 500, in other embodiments, the outer package shell has its own user port, which serves as the user port of the final memory device, and internal leads that electrically connect the user port of the interim package to the user port of the outer package shell.

As indicated by the wide variety of exemplary memory devices described above, the video kiosk 100 can use any suitable type of memory device (e.g., a memory device with two separate ports or a dual-use port, a pre-assembled memory device or a memory device that is assembled by the video kiosk 100 from an interim package and an outer package shell, etc.). Also, a video kiosk 100 can stock a single type of memory device or a variety of different types of memory devices (even including those without high-speed programming functionality). To simplify the following discussion, the memory architectures and programming techniques described below will be discussed only in reference to the memory device 500 in FIG. 5 instead of each of the other previously-described memory devices. However, it should be understood that these memory architectures and programming techniques can be used with the other previously-described memory devices as well as other types of memory devices.

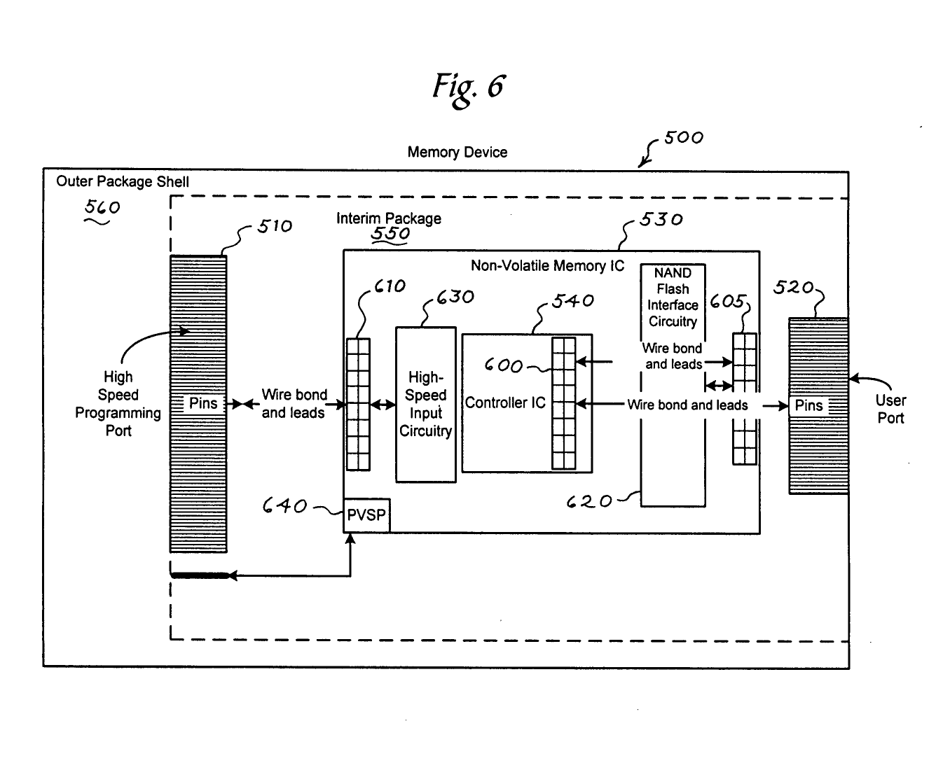

Returning to the drawings, FIG. 6 is a more detailed physical illustration of the memory device 500 shown in FIG. 5. As shown in FIG. 6, in this embodiment, the controller IC 540 is preferably attached to the top of the non-volatile memory IC 530. (It should be noted that while a single non-volatile memory IC is shown in FIG. 6, a stack of non-volatile memory ICs can be used.) The controller IC 540 and the non-volatile memory IC 530 each have respective groups of pads 600, 605 that are connected together with wire bonds and I/O leads. The group of pads 600 of the controller IC 540 is also connected to the pins of the user port 520 with wire bonds and I/O leads. The non-volatile memory IC 530 comprises an additional group of pads 610, which are connected to the pins of the high-speed programming port 510 with wire bonds and I/O leads. The two groups of pads 605, 610 of the non-volatile memory IC 530 are also connected to NAND interface circuitry 620 and high-speed input circuitry 630, respectively, which will be discussed in more detail below. The non-volatile memory IC 530 also comprises a programming voltage supply pad (PVSP) 640, which is connected to a pin at the edge of the interim package 550.

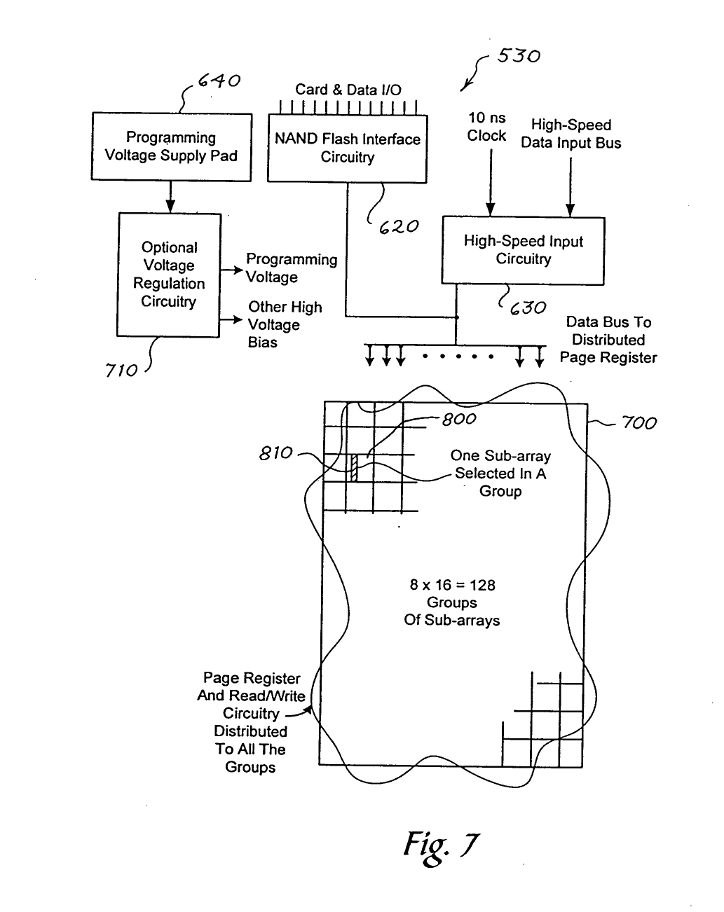

FIG. 7 is a more-detailed illustration of the non-volatile memory IC 530. As shown in FIG. 7, the non-volatile memory IC 530 comprises the NAND interface circuitry 620, the high-speed input circuitry 630, and the programming voltage supply pad (PVSP) 640 shown in FIG. 6. FIG. 7 also shows that the non-volatile memory IC 530 further comprises a memory array 700 and optional voltage regulation circuitry 710, which regulates voltage supplied from the programming voltage supply pad 640 to provide programming voltage and other high voltage bias. To simplify the drawing, certain other supporting circuits (e.g., decoders, sensing circuits, multiplexers, input/output buffers, etc.) are not specifically shown. The NAND Flash interface circuitry 620 is designed according to NAND Flash specifications and provides an interface between the memory array 700 and the user port 520. Although the user port 520 and NAND Flash interface circuitry 620 are primarily used to read video content out of the memory array 700, the user port 520 and NAND Flash interface circuitry 620 can also be used to write data (video or otherwise) to the memory array 700. The high-speed input circuitry 630 receives video content data from the video kiosk 100 over the high-speed programming port 510 and latches this data based on a 10 ns clock. Both the NAND Flash interface circuitry 620 and the high-speed input circuitry 630 are coupled with the memory array via a data bus that is distributed to a page register associated with the memory array 700. In one embodiment, the high-speed programming port 510 is a 16-pin port, and a 10 ns clock input to the high-speed input circuitry 630 captures 16 bits of input data off of the high-speed data input bus every 5 ns cycle (i.e., at the rising and falling edges of the clock). This allows the page register to be loaded at a rate of about 400 MB/s.

Even with this configuration of the high-speed programming port 510 and the high-speed input circuitry 630, a memory device may have one or more limitations that prevent it from being programmed at a sufficiently fast speed. For example, in some memory devices, one of the principle limitations on programming speed is power. Accordingly, even with a high-speed programming port, a memory device may not be able to generate enough power on its own to program its memory array at a sufficiently high rate. This is especially true for conventional memory devices used with portable consumer electronics. While a memory device can be modified to include charge pumps or other components to provide the needed power, the relatively large amount of area needed for those components may not be available on the IC. Accordingly, in this embodiment, the non-volatile memory IC 530 preferably comprises a programming voltage supply pad (PVSP) 640, through which the video kiosk 100 can supply some or all of the needed programming voltage to the memory device 500 from a 110 volt outlet via the power cord 170 (see FIG. 1b). In the embodiment shown in FIG. 6, the programming voltage supply pad 640 and pin that connects to the video kiosk 100 are part of the interim package 550 and are concealed when the interim package 550 is assembled into the outer package shell. In other embodiments, the programming voltage supply pad and/or pin is accessible on the memory device after the memory device is delivered to the user. Additional details about using an external programming voltage are provided below.

Another limitation that may prevent a memory device from being programmed at a sufficiently fast speed is the type of memory used in the memory array. For example, some memory types, such as NAND Flash, require several programming cycles to charge a memory element, determine whether the charge is present in the memory element, and then determine the level of the charge, if present. These various programming cycles add to the time needed for the video kiosk 100 to program video content into the memory device, and this extra time may cause the programming time to exceed a desired threshold. Accordingly, it may be desired to use a type of memory array that does not require as many programming cycles. For example, in one preferred embodiment, the memory array comprises a plurality of passive element memory cells comprising a diode and a switchable-resistance material (such as an antifuse layer). Because this type of memory cell is programmed simply by rupturing the diode, programming such a memory cell is a “blow-and-go” operation and does not require the various programming cycles used by NAND Flash. Accordingly, using a memory array of passive element memory cells comprising a diode and a switchable-resistance material (such as an antifuse layer) can provide faster programming bandwidth than NAND Flash or other types of memory arrays. In other embodiments, the antifuse memory element is replaced by a re-writable memory material such as a thin layer of nickel oxide, aluminum oxide, titanium oxide, PCMO, carbon-nano tubes, lightly-doped silicon, or other switchable-resistance materials. Additional details about a preferred diode-antifuse memory array are provided below.

Yet another limitation on programming speed is localized heating of the memory array to harmful temperatures. Even if a memory device is equipped with a high-speed programming port, power voltage supply pad, and/or a fast enough memory array to allow high-speed programming, localized heating of the memory array caused by high-speed programming can result in memory cells being damaged or the memory chip melting. Several techniques can be used to avoid localized heating of the memory array to harmful temperatures. For example, the video kiosk 100 can be equipped with a cooling system that cools the memory device as video content is being programmed into the memory device. As another example, the write circuitry in the memory device can be designed to program video content data in a distributed manner in the memory array to avoid localized heating. As programming data in a distributed manner may incur its own time penalty, it may be preferred to distribute data in an efficient manner. For example, in one presently preferred embodiment, which will be described in more detail below, the memory array is organized into a plurality of sub-arrays, and video content data is distributed among the plurality of sub-arrays. The memory device can also comprise a temperature sensor and circuitry operative to control the programming of the video content data based on a temperature sensed by the temperature sensor. For example, the circuitry can delay a programming operation or select fewer sub-arrays for programming if the temperature sensed by the temperature sensor exceeds a threshold amount.

With the general programming techniques and memory organization having been presented, the following paragraphs will describe a presently preferred memory architecture for use in a video kiosk environment. It again should be noted that any details presented herein are meant merely to illustrate the embodiments and should not be read into the claims unless explicitly recited therein. Also, the various embodiments can be used alone or in combination with one another.

Staring first with the architecture of the memory array 700, it is presently preferred that the memory array 700 take the form of a three-dimensional memory array. As used herein, a three-dimensional memory array refers to a memory array comprising a plurality of layers of memory cells stacked vertically above one another above a single silicon substrate. In this way, a three-dimensional memory array is a monolithic integrated circuit structure, rather than a plurality of integrated circuit devices packaged or die-bonded in close proximity to one another. Although a three-dimensional memory array is preferred, the memory array 700 can instead take the form of a two-dimensional (planar) array. The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 6,034,882; 6,185,122; 6,420,215; 6,631,085; and 7,081,377. Additional details of bias conditions, bias circuits, and layer decoder circuits particularly suitable for a three-dimensional memory array of write-once antifuse passive element memory cells are described in U.S. Pat. No. 6,618,295, which is hereby incorporated by reference.

In this embodiment, the memory cells in the three-dimensional memory array 700 are preferably passive element memory cells comprising a diode and a switchable resistance material (such as an antifuse layer) arranged in a vertical pillar between X lines (i.e., word or row lines) and Y lines (e.g., bit or column lines), as described in more detail in U.S. Pat. No. 6,951,780, which is hereby incorporated by reference. As compared to some other types of memory technology, passive element memory cells are very low cost. As used herein, a passive element memory array includes a plurality of two-terminal memory cells, each connected between an associated X-line and an associated Y-line. Each such memory cell has a non-linear conductivity in which the current in a reverse direction (i.e., from cathode to anode) is lower than the current in a forward direction. Application of a voltage from anode to cathode greater than a programming level changes the conductivity of the memory cell. The conductivity may decrease when the memory cell incorporates a fuse technology or may increase when the memory cell incorporates an antifuse technology. Such passive element memory cells may generally be viewed as having a current steering element directing current in one direction and another component that is capable of changing its state (e.g., a fuse, an antifuse, a capacitor, a resistive element, etc.). In certain preferred embodiments, the memory element is a diode-like structure having a p+ region separated from an n− region by an antifuse element. When the antifuse element is programmed, the p+ region is electrically connected to the n− region and forms a diode. The programming state of the memory element can be read by sensing current flow or voltage drop when the memory element is selected. In an alternative organic PEMA embodiment, the memory element is a diode-like structure having an anode region separated from a cathode region by an organic material layer whose conductivity changes as electrons are injected into the layer.

Preferably, the memory cells are comprised of semiconductor materials, as described in U.S. Pat. Nos. 6,034,882; 5,835,396; 6,420,215; and 6,515,888, each of which is hereby incorporated by reference. Although an antifuse memory cell is preferred, other types of memory arrays that are stackable over support circuits can be used, such as magnetoresistive random access memory (MRAM) and organic passive element arrays. MRAM is based on magnetic memory elements, such as a magnetic tunnel junction (MTJ), and is described in “A 2556 kb 3.0V ITIMTJ Nonvolatile Magnetoresistive RAM” by Peter K. Naji et al., published in the Digest of Technical Papers of the 2001 IEEE International Solid-State Circuits Conference, ISSCC 2001/Session 7/Technology Directions: Advanced Technologies/7.6, Feb. 6, 2001 and pages 94-95, 404-405 of ISSCC 2001 Visual Supplement, both of which are hereby incorporated by reference. Certain passive element memory cells incorporate layers of organic materials including at least one layer that has a diode-like characteristic conduction and at least one organic material that changes conductivity with the application of an electric field. U.S. Pat. No. 6,055,180 describes organic passive element arrays and is hereby incorporated by reference. Memory cells comprising materials such as phase-change materials and amorphous solids can also be used. See U.S. Pat. Nos. 5,751,012 and 4,646,266, both of which are hereby incorporated by reference. Memory cells can also comprise resistance change materials including transition metal oxides, as described in more detail in U.S. patent application Ser. No. 11/287,452, which is hereby incorporated by reference, and carbon nano-tube layers, which may be formed as described in U.S. patent application Ser. Nos. 10/860,432; 10/860,334; and 09/915,093; which are also hereby incorporated by reference.

Although the memory cells in the memory array 700 are preferably one-time programmable to increase programming bandwidth, some or all of the memory cells in the memory array 700 can be rewritable memory cells, as described, for example, in U.S. patent application Ser. No. 11/237,167, which is hereby incorporated by reference. In general, a rewritable memory cell may incorporate a reprogrammable memory material for which the conductivity may decrease or increase after application of a suitable electrical pulse. Additional alternatives can be used. For example, in the above description, an array line was generally shared by two levels of the memory array (i.e., memory planes). Alternatively, a memory array can be fabricated having two conductors for each plane that are not shared with other planes. A dielectric layer may be used to separate each such memory level. Also, while X-lines are usually orthogonal to Y-lines, they do not have to be. Moreover, the word and bit line organization of a memory array may also be easily reversed, having Y-lines organized as word lines and X-lines organized as bit lines. As an additional example, portions of an array may correspond to different output bits of given word.

Additionally, in some embodiments, a selected word line is driven to a voltage, and a selected bit line is sensed in a read mode, with memory cell anode terminals connected to word lines and cathode terminals connected to bit lines. However, other arrangements can be used. For example, in a three-dimensional (i.e., multi-level) memory array, an adjacent memory plane can be connected with a back-to-back diode stack memory array, as described in U.S. Pat. No. 6,034,882 (referred to above), or the directionality of memory cells can be reversed in the adjacent plane (e.g., a serial chain diode stack memory array as described in U.S. Pat. No. 6,631,085, which is hereby incorporated by reference) so that the anode terminals are connected to bit lines and the cathode terminals to word lines. Consequently, the designations herein of X-lines, word lines, row lines, Y-lines, bit lines, and column lines are illustrative and should not be viewed in a restrictive sense. For example, sensing circuits may be coupled to word lines rather than bit lines or may be used for both word lines and bit lines. It should be appreciated that the designations X-line and Y-line for various array lines of a memory array on a serial chain diode stack do not necessarily imply which terminal of the memory cells (i.e., anode or cathode) is coupled to the particular line, as with a back-to-back diode stack. An X-line may be coupled to the anode terminal of memory cells in one associated memory plane and may be coupled to the cathode terminal of memory cells in an adjacent memory plane.

Returning to the drawings, as shown in FIG. 7, the memory array 700 in this preferred embodiment is organized into a plurality of sub-arrays (specifically, 128 groups of sub-arrays formed from a 8×16 division of the memory array 700). As used herein, a sub-array is a contiguous group of memory cells having contiguous word and bit lines generally unbroken by decoders, drivers, sense amplifiers, and input/output circuits. In a presently preferred embodiment, the three-dimensional memory array 700 comprises a plurality of passive element memory cells formed by a silicon diode and an antifuse memory element in a vertical pillar arrangement between X-lines and Y lines, as described in U.S. Pat. No. 6,951,780, which is hereby incorporated by reference.

In this embodiment, there are 8,192 memory cells on an X-line and 1,024 memory cells on a Y-line on each layer. The memory array 700 comprises eight layers of Y-lines and four layers of X-lines, which are associated with memory cells both above and below the X-lines. Each memory sub-array also has eight layers of memory cells. An X-line is selected for programming by applying ground bias. Multiple programming circuits associated with a sub-array drive multiple Y-lines to a programming voltage for a programming time of about 250 ns to program multiple cells associated with the X-line and Y-line. Unselected cells have a reverse bias, which causes a diode leakage current of about 1 pico Amp on about 64 million cells. This consumes a relatively significant amount power and can limit the number of sub-arrays that can be selected for programming simultaneously. In order to increase the programming bandwidth, one or more of the various techniques described above can be used (e.g., using an external source of programming voltage, controlling the number of sub-arrays that are programmed, distributing page data over many sub-arrays, and using temperature feedback circuitry). Further, as diode leakage increases exponentially with temperature, it is preferred that the video kiosk 100 comprise a cooling system to maintain chip temperature at about 40 degrees C. or lower, as will be described below.

The memory cells are preferably organized in many sub-arrays in an arrangement that allows high-programming bandwidth, as described in U.S. Pat. No. 7,106,652, which is hereby incorporated be reference. Higher-speed programming for antifuse memory cells can be accomplished by controlling the programming time using programming and read circuits that incorporate a method for sensing while programming, as described in more detail in U.S. Pat. No. 6,574,145, which is hereby incorporated by reference.

Because the memory array 700 is organized into many sub-arrays that are separately selectable in groups of one or more sub-arrays, various data bits of a data set can be physically spread out and mapped into a large number of associated sub-array groups to distribute the heat of the programming operation and achieve the highest possible programming data rate, as described in more detail in U.S. Pat. No. 6,633,509, which is hereby incorporated by reference. Preferably, the page register that contains the data to be programmed is divided into many portions, with each portion being associated with a sub-array and programming circuits, so data is programmed in parallel to many sub-arrays. In this way, the data to be programmed is organized so that a maximum number of sub-arrays are activated for programming simultaneously.

As programming in this fashion can still lead to overheating, it is presently preferred that the video kiosk 100 contain a cooling system (as described below) to keep the temperature of the memory IC below 40 degrees C. This should allow the maximum number of sub-arrays containing data to be safely programmed simultaneously. Additionally or alternatively, the non-volatile memory IC 530 can comprise a temperature sensor and circuitry responsive to the temperature sensor to delay programming operations or to reduce the number of sub-arrays activated for programming simultaneously based on the temperature of the IC 530. A preferred method of controlling programming conditions based on temperature is described in more detail in U.S. Pat. No. 6,735,546, which is hereby incorporated by reference.

Further, as discussed above, the non-volatile memory IC 530 in this embodiment comprises a programming voltage supply pad 640, which preferably receives an external source of programming voltage of about 4 volts to 15 volts, as required by the memory cells. Since the high voltage is not generated on chip, the number of sub-arrays active for programming simultaneously and the number of bits in each sub-array being programmed can increase without overheating the memory IC 530. The use of an external source of programming voltage is described in more detail in U.S. Pat. No. 6,545,898, which is hereby incorporated by reference. As discussed above, in this embodiment, the external source of programming voltage preferably comes from the video kiosk 100.

Turning now to a specific example, in this embodiment, the high-speed input circuitry 630 acts as a latch that captures data on the 16-data-input-line high-speed bus every 5 ns (i.e., on the rising and falling edges of the 10 ns clock). (The high-speed input circuitry 630 can also handle differential voltage when the high-speed programming port is a PCI Express interface). As shown in FIG. 7, the high-speed input circuitry 630 drives a data bus that has many lines that go to a distributed page register under the memory array 700. In this embodiment, the memory array 700 is divided into 128 groups of sub-arrays, with each sub-array comprising 16 sub-arrays. One such sub-array is shown in FIG. 7 as a shaded box 810 in sub-array group 800. Accordingly, within one sub-array group, there is one selected sub-array. Since there are 128 sub-array groups, in this embodiment, up to 128 sub-arrays would be programmed in parallel at a given time (i.e., one sub-array in each of the 128 groups). Because these sub-arrays are distributed across the memory array 700, the heat generated by the programming is also distributed across the memory array 700.

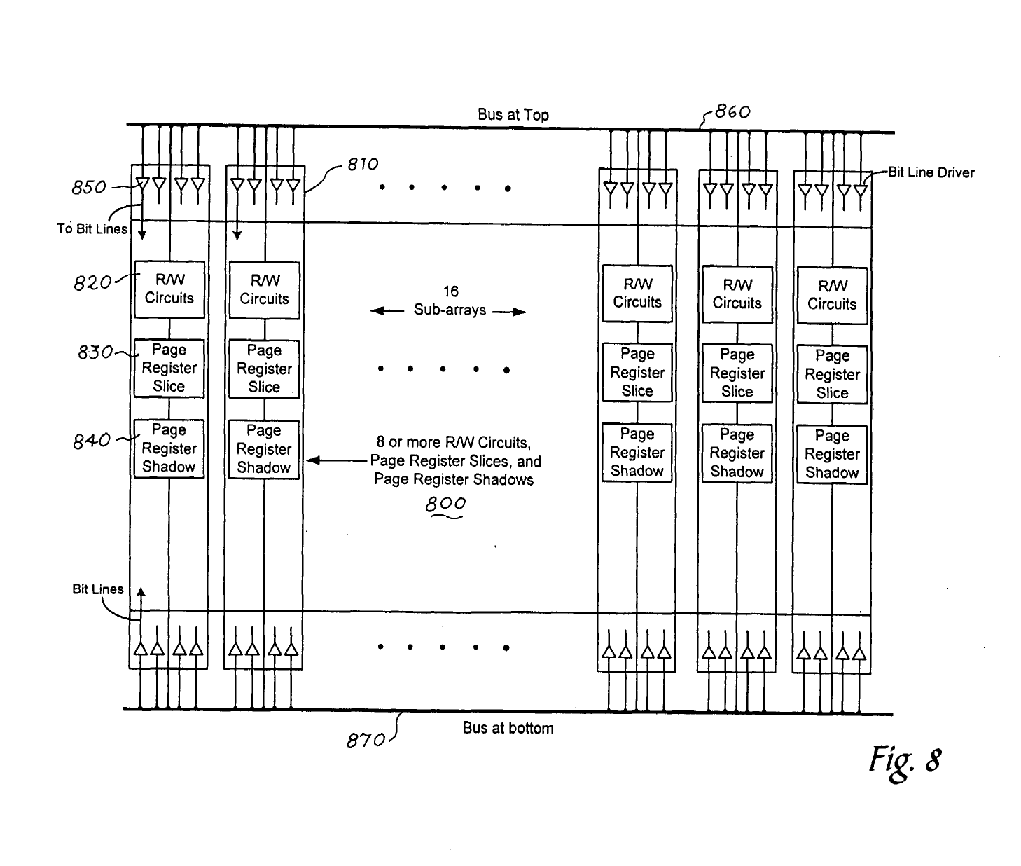

To program the 128 sub-arrays in parallel, a distributed page register is used. FIG. 8 shows a sub-array group and 16 sub-arrays in that group. Each sub-array comprises read/write circuits 820, a page register slice 830, and a page register shadow 840. (The number of read circuits can be larger than the number of write circuits). A bus 860 connects the read/write circuits 820 to bit line driver circuits 850 located near the edge of the sub-arrays. (Preferred array line drivers are described in U.S. Pat. Nos. 6,856,572 and 6,859,410, which are hereby incorporated by reference.) A second bus 870 can be used, so one bus 860 is at the top of the sub-arrays, and another bus 870 is at the bottom. Also, there can be twice as many groups of sub-arrays for a larger capacity chip, and the read/write circuits and page register slices can be shared between pairs of sub-array groups. For example, a group of 16 sub-array groups may only have eight read/write circuits.

Data from the high speed input circuitry 630 is temporarily stored in a page register that is distributed as 128 portions associated with the 128 groups of sub-arrays. Each individual page register slice 830 has 32 bits of information associated with the 32 cycles to complete a page of programming. The shadow page register 840 has the same structure as the page register 830 and is associated one-to-one with the page register 830. While the page register data is being programmed, the shadow page register 840 can be loaded with the next page of data from the high speed input circuitry 630. A highly-parallel transfer of data from shadow page register 840 to the page register slice 830 is used. Thus, the programming operation is pipelined to increase sequential page programming performance by almost two times.

In one embodiment, 128 sub-arrays are activated for programming, with eight cells selected for programming simultaneously in each sub-array. 32 cycles of programming complete the programming of a page of data containing 4,096 bytes of data. (The page size may not be exactly 4,096 bytes because of extended page space and other overhead.) Each programming cycle (including overhead to bias sub-arrays and control write circuits) is about 320 ns. Therefore, a programming data rate of 400 MB/sec can be achieved.

In conclusion, it should again be noted that the examples set forth above were merely used to illustrate these embodiments and are not intended as a limitation on the claims. Various alternatives can be used, and the details set forth above should not be read into the claims unless explicitly recited therein.

### Exemplary Mechanical and Electrical Components of a Video Kiosk

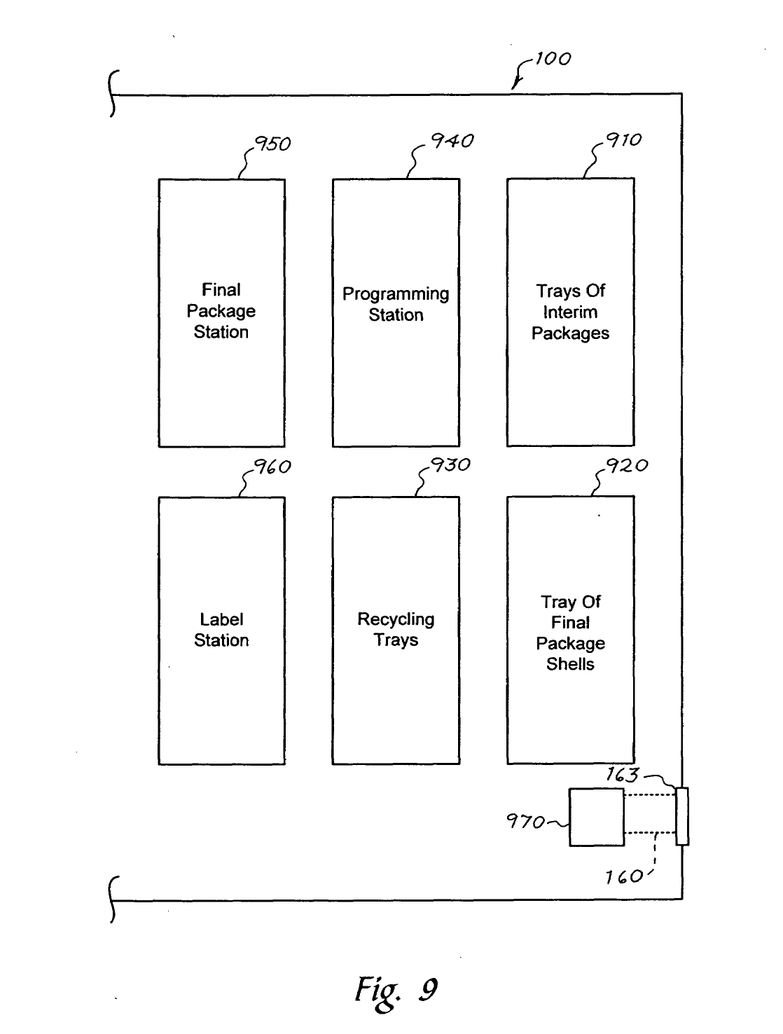

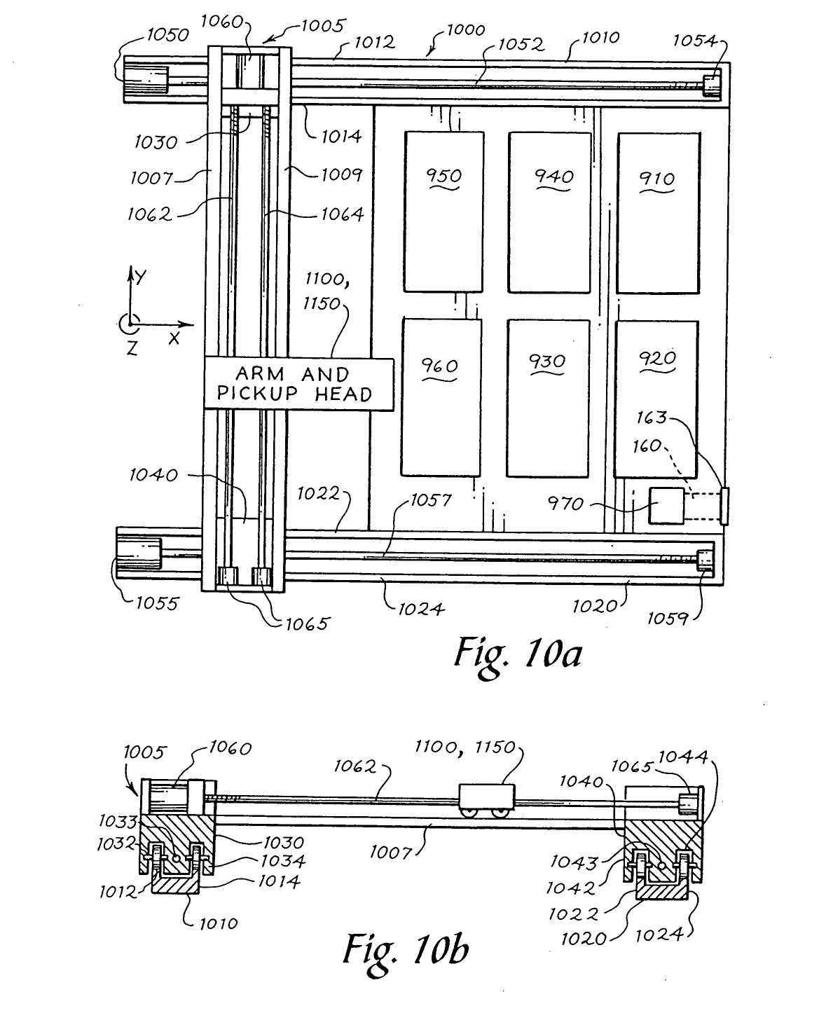

Returning to the drawings, FIG. 9 is a diagrammatic illustration of some of the internal components of the video kiosk 100. As shown in FIG. 9, the video kiosk 100 of this embodiment comprises a tray of interim packages 910, a tray of final (or “outer” (“final” and “outer” will be used interchangeably herein)) package shells 920, recycling trays 930, a programming station 940, a final package station 950, and a label station 960. FIG. 9 also shows the swinging door 163 in the removable panel 165 from FIG. 1, as well as the memory device output chute 160 and an opening 970 in communication with the chute 160. Although not shown in FIG. 9 to simplify the drawing, the video kiosk 100 also comprises a transport mechanism that moves a memory device (sometimes in interim form and other times in final form) to the various processing stations in the video kiosk 100 and, ultimately, delivers the final memory device to the user. FIGS. 10a and 10b are top and rear views, respectively, of an exemplary transport mechanism 1000 that can be used with this embodiment. As shown in these figures, the transport mechanism 1000 comprises a carriage assembly 1005 that moves along first and second tracks 1010, 1020 and carries an arm 1100 that moves along the carriage assembly 1005 and supports a pickup head 1150. Each of these components will be discussed in more detail below.

Turning first to the movement of the carriage assembly 1005, the first and second tracks 1010, 1020 each comprise two rails 1012, 1014, 1022, 1024, which can be integral with or separate from the tracks 1010, 1020. The carriage assembly 1005 comprises first and second carriage components 1030, 1040, each with two wheels 1032, 1034, 1042, 1044 that rest on the rails 1012, 1014, 1022, 1024 of the respective tracks 1010, 1020 and allows the carriage components 1030, 1040 to roll thereupon. (In an alternate embodiment, instead of using wheels, the first and second carriage components 1030, 1040 can rest directly on and slide along the rails 1012, 1014, 1022, 1024.) In this embodiment, first and second screw drives 1050, 1055 are used to move the carriage assembly 1005 along the first and second tracks 1010, 1020. (Although any type of movement mechanism can be used, screw drives 1050, 1055 are preferred in this embodiment because they provide precision and good range of motion in a constrained space.) Each screw drive 1050, 1055 is coupled with a respective screw 1052, 1057, which is supported by a respective screw support 1054, 1059. The first and second carriage components 1030, 1040 each comprise respective holes 1033, 1043 through which the respective screws 1052, 1057 are threaded. As the screw drives 1050, 1055 turn the screws 1052, 1057 in one direction, the first and second carriage components 1030, 1040 (and, thus, the carriage assembly 1005) move from left to right along the first and second tracks 1010, 1020. Similarly, as the screw drives 1050, 1055 turn the screws 1052, 1057 in the opposite direction, the first and second carriage components 1030, 1040 (and, thus, the carriage assembly 1005) move from right to left along the first and second tracks 1010, 1020. Through this movement, the screw drives 1050, 1055 can move the pickup head 1150 to a desired location along the X axis.

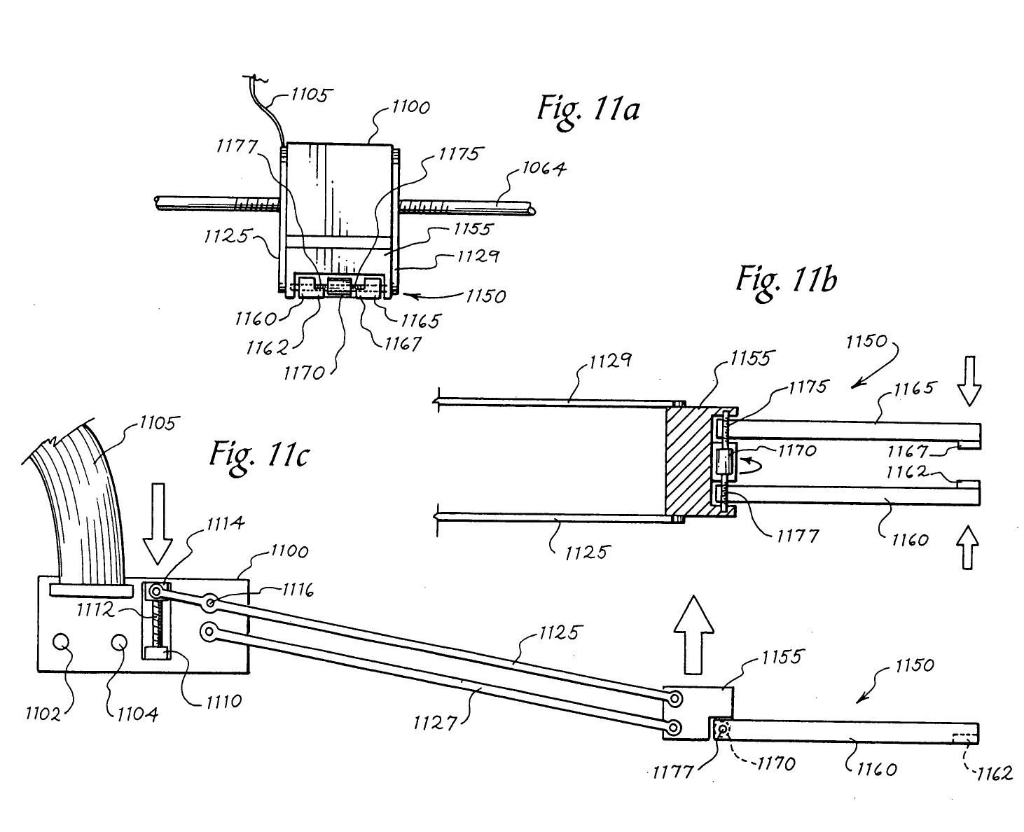

The carriage assembly 1005 contains two lateral support rails 1007, 1009 and components to move the arm 1100 and pickup head 1150 along the two lateral support rails 1007, 1009 in the Y direction. Specifically, the carriage assembly 1005 comprises dual screw drives 1060 that turn screws 1062, 1064, which are supported by screw supports 1065 and are threaded through two holes 1102, 1104 in the arm 1100 (see FIG. 11c). As the dual screw drives 1060 turn the screws 1062, 1064 in one direction, the arm 1100 (and, thus, the pickup head 1150) moves from the top to the bottom of the drawing along the two lateral support rails 1007, 1009. Similarly, as the dual screw drives 1060 turn the screws 1062, 1064 in the opposite direction, the arm 1100 (and, thus, the pickup head 1150) moves from the bottom to the top of the drawing along the two lateral support rails 1007, 1009. Through this movement, the dual screw drives 1060 can move the pickup head 1150 to a desired location along the Y axis.

The arm 1100 and pickup head 1150 are shown in more detail in FIGS. 11a, 11b, and 11c (some of the components shown in FIGS. 10a and 10b are not shown here to simply the drawings). As shown in these drawings, the arm 1100 has two holes 1102, 1104 through which the screws 1062, 1064 discussed above are threaded, and a flexible electrical cable 1105 attaches to the arm 1100 to supply electrical and command signals to the arm 1100 from control circuitry of the video kiosk 100. A plurality of support arms 1125, 1127, 1129 (and another support arm not visible in these drawings) pivotably connects the arm 1100 to the body 1155 of the pickup head 1150. The arm 1100 also comprises a screw drive 1110 that drives a screw 1112 threaded through a component 1114 that is pivotably coupled with two of the support arms 1125, 1129. As shown diagrammatically in FIG. 11c, as the screw drive 1100 moves the component 1114 down, the support arms 1125, 1129 move the body 1155 of the pickup head 1150 (and, thus, the entire pickup head 1150) up. Through this movement, the screw drive 1100 can move the pickup head 1150 to a desired location along the Z axis. (As will be described below, translation in the Z axis is preferred in this embodiment since the trays 910, 920 are stacked and since the opening 970 for the delivery chute 160 is at a higher plane than the first and second tracks 1010, 1020.) In addition to the body 1155, the pickup head 1150 comprises two fingers 1160, 1165 with grips 1162, 1167. The pickup head 1150 further comprises a screw drive 1170 and screws 1175, 1177 threaded through the two fingers 1160, 1165. As shown diagrammatically in FIG. 11b, when the screw drive 1170 is activated in one direction, the two fingers 1160, 1165 move closer together. Similarly, when the screw drive 1170 is activated in the opposite direction, the two fingers 1160, 1165 move farther apart.

In summary, the transport mechanism 1000 allows the fingers 1160, 1165 of the pickup head 1150 to move to any desired X, Y, and Z location in the video kiosk 100, so that the grips 1162, 1167 of the pickup head 1150 can move the memory device component to the various processing stations in the video kiosk 100 and, ultimately, deliver the final memory device product to the user. By way of example only, in one embodiment, the fingers 1160, 1165 are about six inches long, the body of the pickup head 1150 is about one inch long, the support arms 1125, 1127, 1129 are about eight inches long, and the arm 1100 is about four inches long. Because there is a shorter distance from the component 1114 to the pivot point 1116 than from the pivot point 1116 to the body 1155 of the pickup head 1150, the screw drive 1114 can translate the pickup head 1150 quite a bit up and down with a relatively small amount of rotation (preferably, the screw drive 1114 can pivot the support arms +/−45 degrees with respect to normal). Also in this embodiment, the dimensions of the trays 910, 920, 930, and the various stations 940, 950, 960 are about six inches left to right and twelve inches top to bottom. Because the fingers 1160, 1165 are about six inches long in this embodiment and the trays 910, 920 are about six inches wide, the grips 1162, 1167 of the fingers 1160, 1165 will be able to grab memory device components anywhere on the trays 910, 920. Also, as mentioned above, because the pickup head 1140 can be translated in the Z direction, the fingers 1160, 1165 of the pickup head 1140 will be able to grab memory device components on stacked trays. In one embodiment, the fingers 1160, 1165 have a height of about a half inch, and there is about two inches or less between two stacked trays.

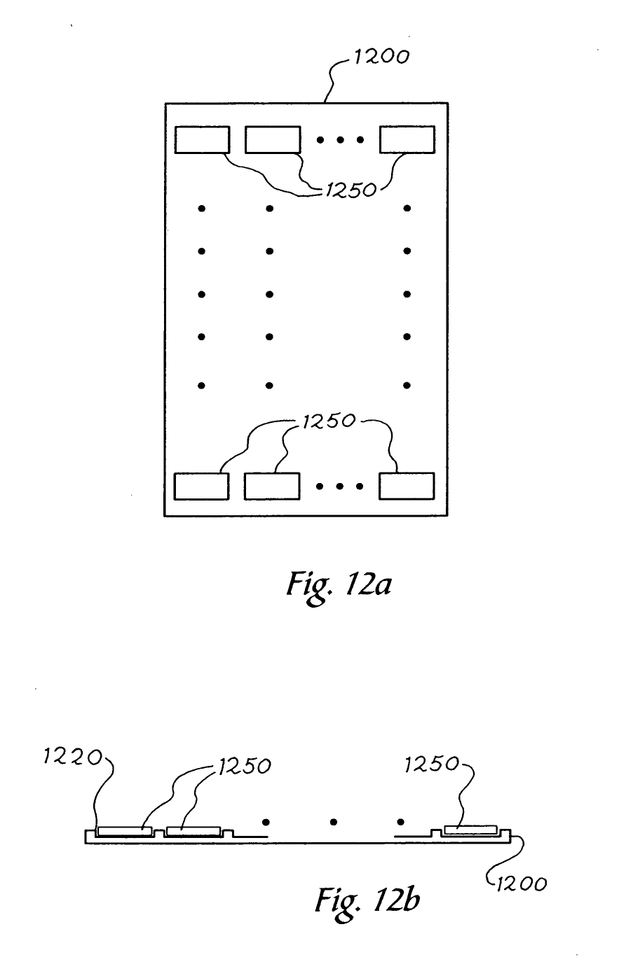

Returning to FIG. 9, in this embodiment, the memory device delivered to the user is assembled from an interim package and a final package shell, and the video kiosk 100 comprises trays 910, 920 for each of those components. FIGS. 12a and 12b are top and side views, respectively, of a tray 1200 of interim packages 1250 of an embodiment. By way of example only, in this embodiment, the tray 1200 is about six inches left to right and twelve inches top to bottom and has depressions 1220 sized such that the interim packages 1250, which are about a half inch by an inch, will slightly protrude from the tray 1200, enabling the grips 1162, 1167 of the fingers 1160, 1165 to grab them. In one embodiment, there are about 50 interim packages 1250 on a tray, and there are several trays (e.g., six trays) stacked above each other in the video kiosk 100 (with shelves in the video kiosk 100 or feet on the trays providing adequate spacing between the trays in the stack to the allow the fingers 1160, 1165 to enter between the trays).

As mentioned above, in this embodiment, both the trays of interim packages 910 and the tray of final package shells 920 are placed in the video kiosk 100 through the removable panel 165 in the front of the video kiosk 100 (see FIG. 1a). (As will be described in more detail below, in this embodiment, the recycling trays 930 are not stackable or removable, but rather serve as a temporary storage location for “recycled” interim packages.) The control system in the video kiosk 100 can electronically control unlocking of the removable panel 165 by requesting user id and password information at the key pad 145 or touch screen 140. In one embodiment, after a service technician loads a tray of interim packages or final package shells into the video kiosk 100, he informs the control system of the video kiosk 100 of the type and quality of components just provided to the video kiosk 100 (e.g., via the touch screen 140, via the key pad 145, or via one of the plurality of ports 180). For example, the service technician can type-in the memory capacity of the interim packages or the package type of final package shells, as well as the rack location in the video kiosk 100 that the tray was inserted into. The control system of the video kiosk 100 can then carry out various bookkeeping functions to verify the entries made by the service technician. For example, the control system can cause the transport mechanism 1000 to take an interim package from the just-inserted interim package tray and place it in the read portion of the programming station 940 (which will be described below) to read the product ID information from the interim package. The control system of the video kiosk 100 can then record the tray and product type information and cause the transport mechanism 1000 to return the interim package to the tray. The control system can then provide confirmation or error information (e.g., a backwards-oriented tray error, an empty tray error, a read error, an error indicating that the product type is inconsistent with the data entered by the service technician, etc.) to the service technician and update inventory control records. Also, instead of just sampling a single interim package, the control system can sample interim packages from several locations on a tray to confirm quantities. Further, instead of having the service technician manually enter tray information into the video kiosk 100, a tray can contain a bar code or some other type of indicia to allow the video kiosk 100 to automatically identify the tray and its contents.

The interim package and the final package shell can take any suitable form. As mentioned above, different interim packages can be used with different memory capacities. This can allow the video kiosk 100 to choose the appropriate interim package based on the size of the selected video content and charge the customer accordingly. Although it is presently preferred in this embodiment that the interim packages have the same shape, in other embodiments, different interim packages can have different shapes (with or without having different memory capacities). Similarly, the video kiosk 100 can stock a variety of different-shaped final package shells, which allows a user or the video kiosk 100 to select a desired form factor/format compatible with the user's memory device player. Examples of the final package shells include, but are not limited to, those that are compatible with the following form factors/formats: CompactFlash™ (CF™) Storage Card, SD™, SD™(HC), MiniSD™(HC), MMC™, MMCPlus™, MMCmobile™, MicroSD™(HC), Memory Stick™, Memory Stick PRO™, Memory Stick Duo™, and Memory Stick PRO Duo™. The next several drawings illustrate several interim packages and final package shells. These drawings are for illustration purposes only, and it should be noted that other types of interim packages and final package shells can be used.

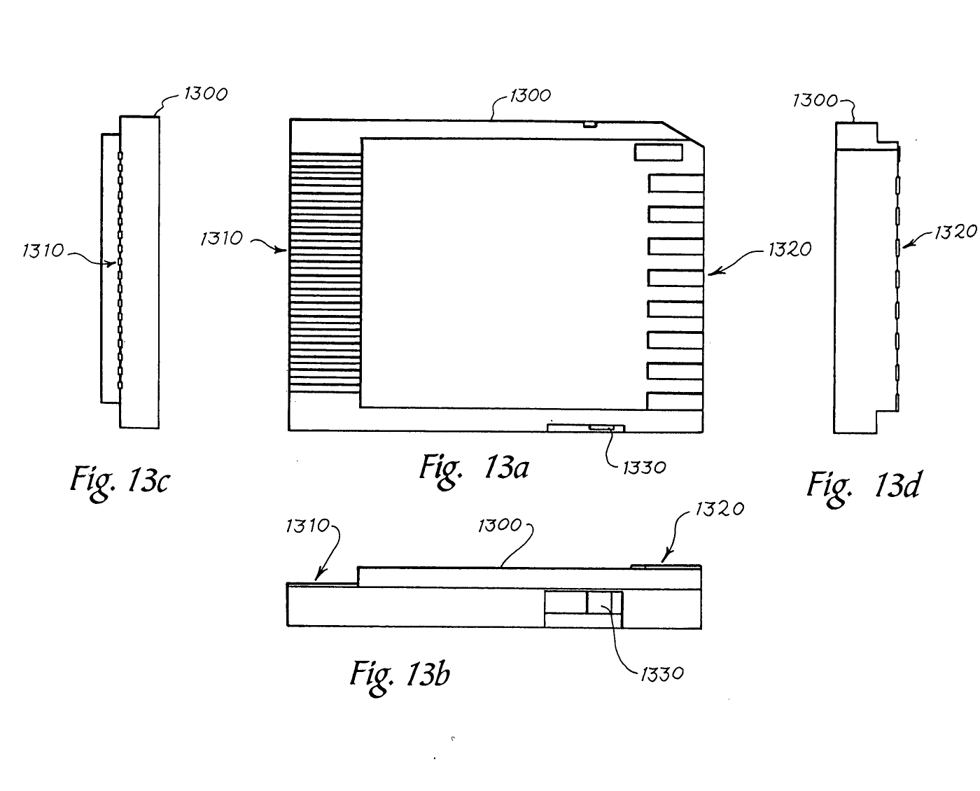

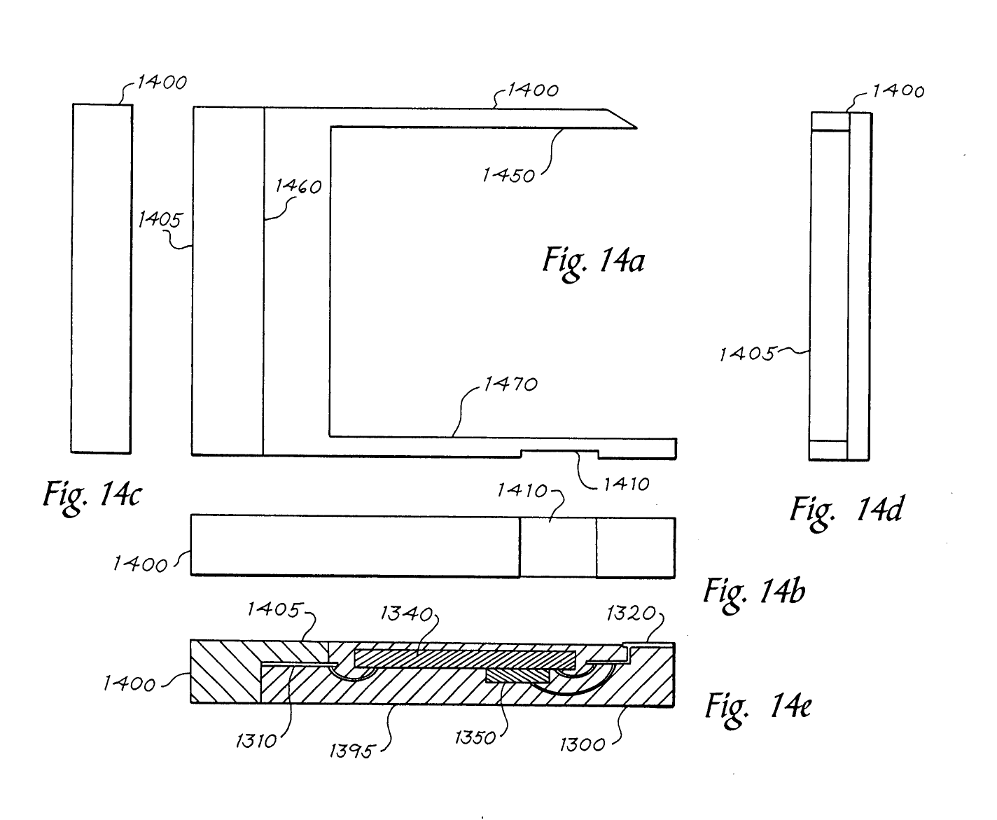

Returning to the drawings, FIGS. 13a, 13b, 13c, and 13d are top, side, rear, and front views, respectively, of an exemplary interim package 1300 in which the high-speed programming pins 1310 and the user pins 1320 are on two surfaces of the same side of the interim package 1300 but are different heights. The interim package 1300 also has a write-inhibit slide switch 1330 on the side of package 1300. FIGS. 14a, 14b, 14c, and 14d are top, side, rear, and front views, respectively, of a final package shell 1400 suitable for use with the interim package 1300 of FIG. 13. As shown in these figures, the final package shell 1400 has a U-shape with a step 1405 and a hole 1410 to allow access to the write-inhibit slide switch 1330 on the side of interim package 1300.

FIG. 14e is a section view of the final package shell 1400 assembled onto the interim package 1300 of FIGS. 13a, 13b, 13c, and 13d. As shown in FIG. 14e, when assembled, the step 1405 covers the high-speed programming pins 1310, which are connected to the non-volatile memory IC 1430 via leads. However, because of the U-shape design of the final package shell 1400, the user pins 1320, which are connected to the controller IC 1440 via leads, of the interim package 1300 remain exposed. So, the final memory device does not have exposed pins that are independent of the interim package 1300. In an alternate embodiment, the final package shell can completely enclose the interim package 1300 and have pins that connect to the user pins 1320 on the interim package 1300. However, the embodiment shown in FIG. 14e may be preferred since it is a simpler electrical design. Also, as discussed in more detail below, the final package shell 1400 can be secured to the interim package 1300 by thermally-settable adhesive on surfaces 1450, 1460, and 1470 of the final package shell 1400. As will also be discussed in more detail below, in this embodiment, the video kiosk 1300 can print a label on the undersign 1395 of the interim package 1300 since it is exposed in the final memory package.

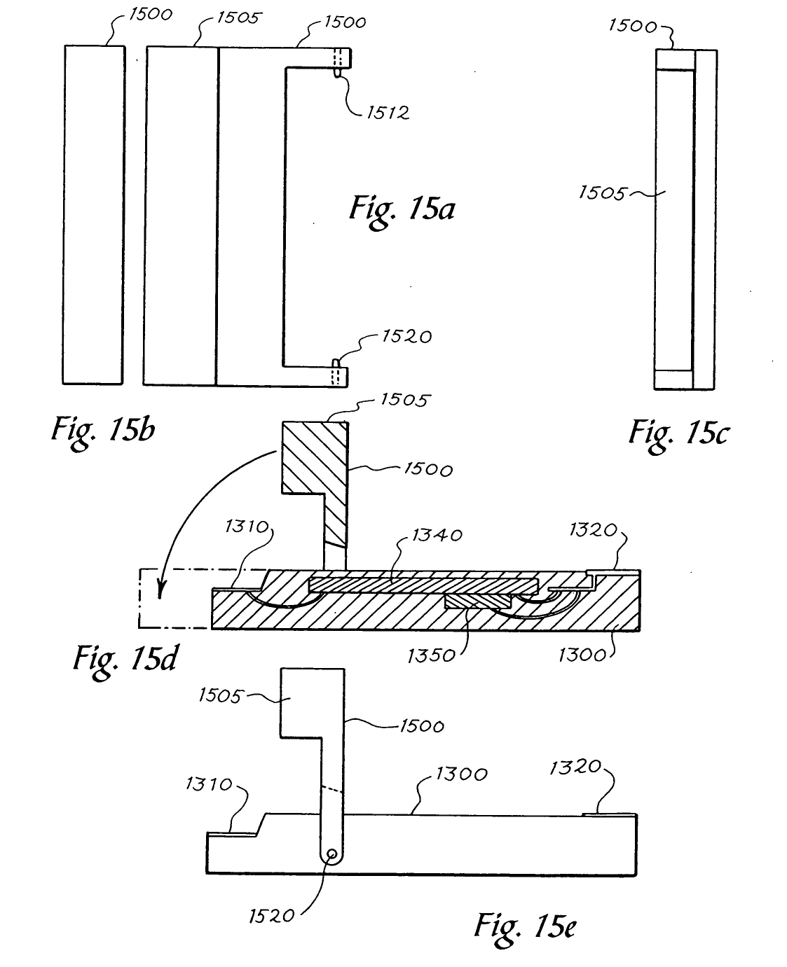

FIGS. 15a, 15b, and 15c are top, rear, and front views, respectively, of an alternate final package shell 1500 that can be used with the interim package 1300 of FIG. 13. As with the final package shell 1400 of FIGS. 14a, 14b, 14c, 14d, and 14e, this final package shell 1500 comprises a step 1505 that covers the high-speed programming pins 1310 of the interim package 1300. However, in this embodiment, the final package shell 1500 is preassembled onto the interim package 1300 using pins 1510, 1520 that fit into recesses in the interim package 1300. In this alternate embodiment, the video kiosk 100 converts the interim package 1300 into a final package by rotating the final package shell 1500 so that the step 1505 covers the high-speed programming pins 1310. This alternative may be more practical than the previous alternative, since it does not involve molding and as precise alignment of the robot arm.

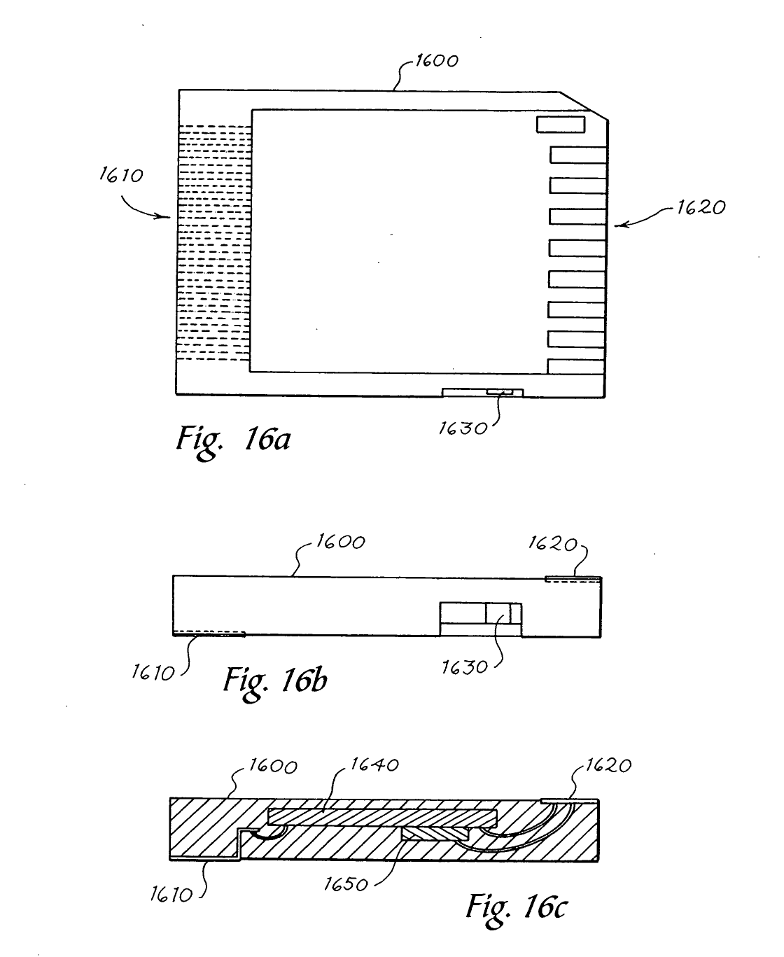

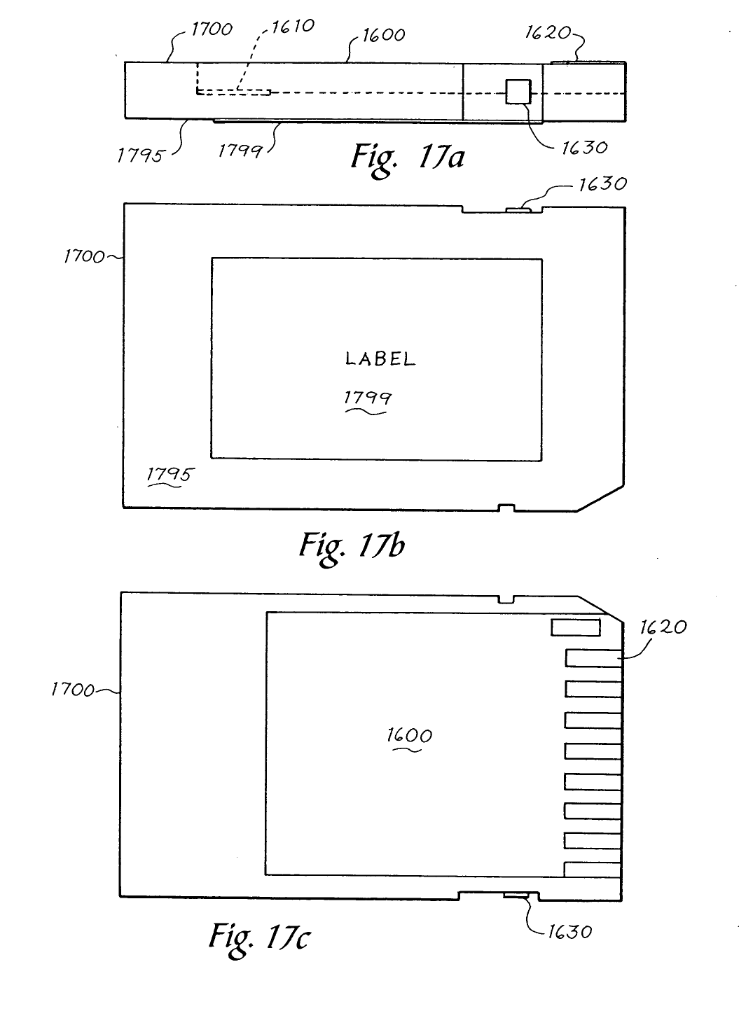

In the previously-described embodiments, the high-speed programming pins 1310 and the user pins 1320 were on two surfaces of the same side of the interim package 1300. In an alternate interim package 1600 shown in FIGS. 16a, 16b, and 16c, the high-speed programming pins 1610 and the user pins 1620 are on two surfaces above and below the non-volatile memory IC 1640 and the controller IC 1650. The interim package 1600 also has a write-inhibit slide switch 1630 on the side of the package 1600. Because the high-speed programming pins 1610 are on the opposite side from the user pins 1620, the final package shells previously described would not cover the high-speed programming pins 1610 on the interim package 1600 of this embodiment. Accordingly, a different final package shell is preferred, such as the final package shell 1700 shown in FIGS. 17a, 17b, and 17c. Instead of the previously-described final package shells which only attach to the sides of the interim package, the final package shell 1700 of this embodiment attaches to both the sides and the bottom of the interim package 1600 to cover the high-speed programming pins 1610 on the bottom of the interim package 1600. Because the underside 1795 of the resulting final memory device is the final package shell 1700, the video kiosk 100 can print the label 1799 on the final package shell 1700 (instead of an interim package, as in the previously-described embodiments).

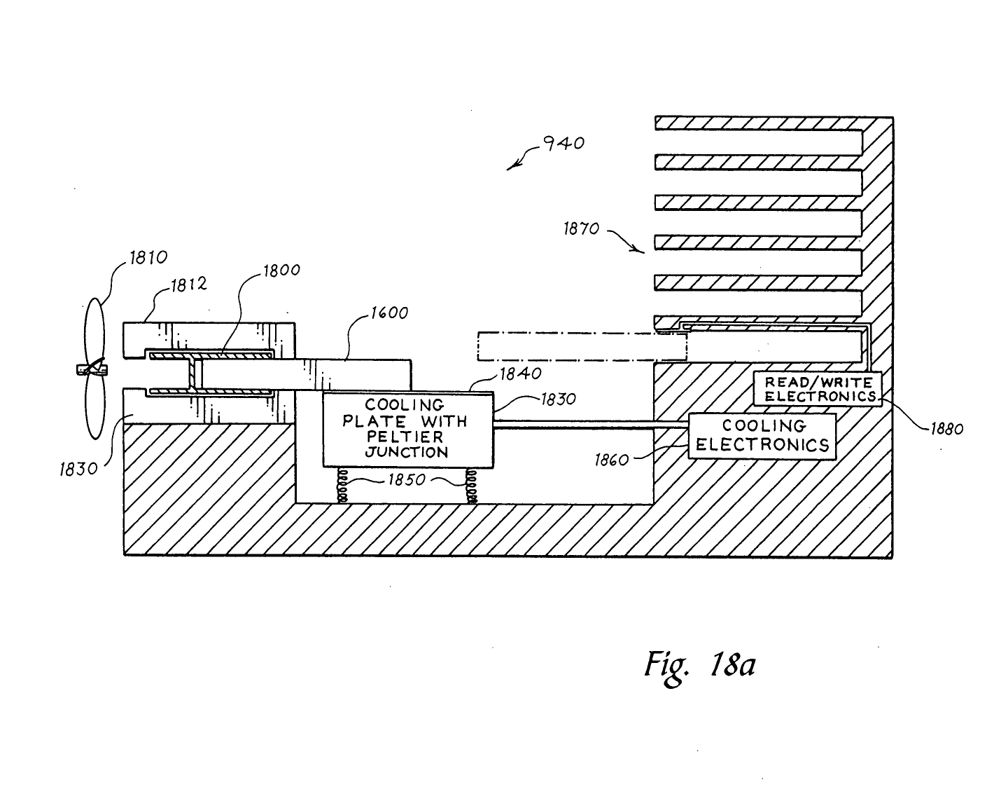

The interim package 1600 of FIG. 16 and the final package shell 1700 of FIG. 17 will now be used to describe the general operation of the video kiosk 100. After a user selects desired video content, the pickup head 1150 (see FIGS. 11a, 11b, and 11c) grabs an interim package 1600 from a tray of interim packages 910 and moves it to the programming station 940 (see FIG. 9). FIGS. 18a and 18b are side and top views of an exemplary programming station 940 of an embodiment. As shown in these figures, the programming station 940 comprises a programming port 1800 with high-speed programming pins on the top and/or bottom of the port 1800 to mate with high-speed programming pins on one or both of the interim packages 1300, 1600 described above (the interim package 1600 in FIG. 16 has high-speed programming pins 1610 on the bottom of the package 1600). Because of the heat generated when programming the interim package 1600 at high-speed programming speeds (as discussed above), the programming station 940 in this embodiment preferably comprises a cooling system, which cools the interim package 1600 as it is being programmed in the programming station 940 (preferably, to maintain chip temperature at about 40 degrees C. or lower). The cooling system in this embodiment comprises a fan 1810 that blows air through cooling fins 1820, 1830 across the interim package 1600 when it is connected to the programming port 1800. The cooling system also comprises a cooling plate 1830 with a Peltier junction. The cooling plate 1830, which comprises a heat conductive surface 1840, is supported by flexible mounts 1850 and is connected to cooling electronics 1860, which control the operation of the cooling plate 1830. (In an alternate embodiment, the interim package has a hole to allow a cooling device to be in direct contact with the memory IC.) The programming station 940 also comprises a plurality of slots 1870 for final memory packages and read/write electronics 1880.

The high-speed programming pins of the programming port 1800 mate with the high-speed programming port 1610 of the interim package 1600 to provide electrical and mechanical communication between the interim package 1600 and the video kiosk 100. Control circuitry (not shown) of the video kiosk 100 then commences programming video content into the memory array of the non-volatile memory IC 1640 of the interim package 1600. As this programming occurs, the fan 1810 and the cooling plate 1830 cool the interim package 1600 to avoid overheating. (In addition to or instead of using the cooling system of the video kiosk 100, the interim package 1600 can use one or more of the above-described programming techniques to avoid overheating.)

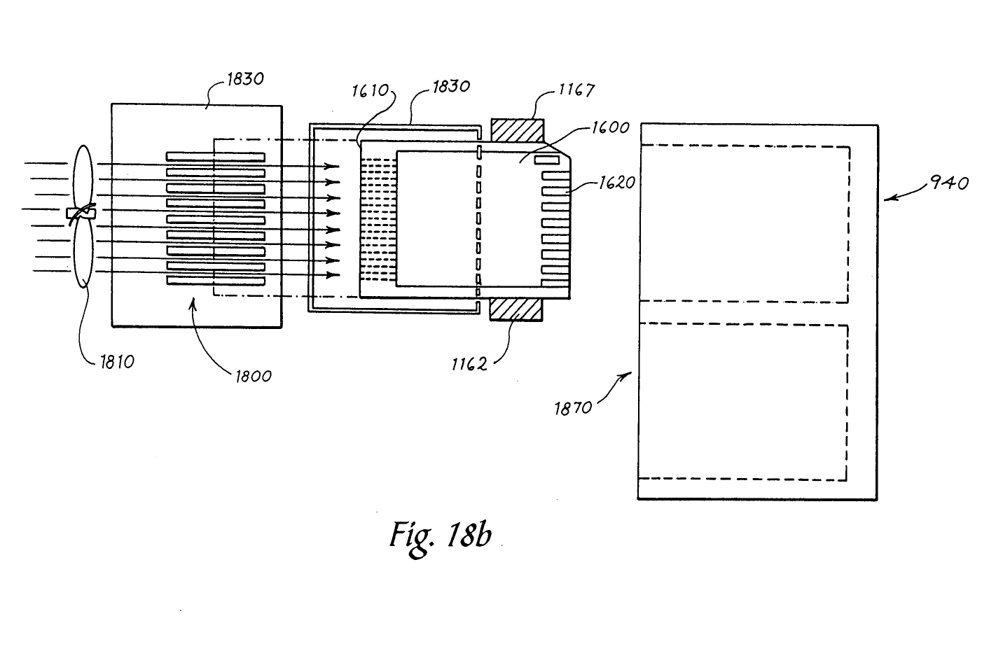

Before, during, or after the programming of the interim package 1600 is complete, the pickup head 1150 grabs the appropriate final package shell 1700 from the tray of final package shells 920 with its finger grips 1162, 1167 and positions it on a mount 1900 in the final package station 950 (see FIG. 19). After the programming of the interim package 1600 is complete, the pickup head 1150 grabs the interim package 1600, removes it from the programming port 1800 of the programming station 940, and presses it onto the final package shell 1700 in the final package station 950. As noted above, in this embodiment, several surfaces of the final package shell 1700 have thermally-settable adhesive, and, when the pickup head 1150 presses the interim package 1600 onto the final package shell 1700 in the final package station 950, the video kiosk 100 activates a heater 1910 to thermally set the adhesive. In an alternate embodiment, only pressure is used to join the interim package and outer package shell. (As will be described in more detail below, if an error occurs while programming the interim package 1600, instead of delivering the interim package 1600 to the final package station 950, the pickup head 1150 can deliver the interim package 1600 to the recycling trays 930 for later use.)

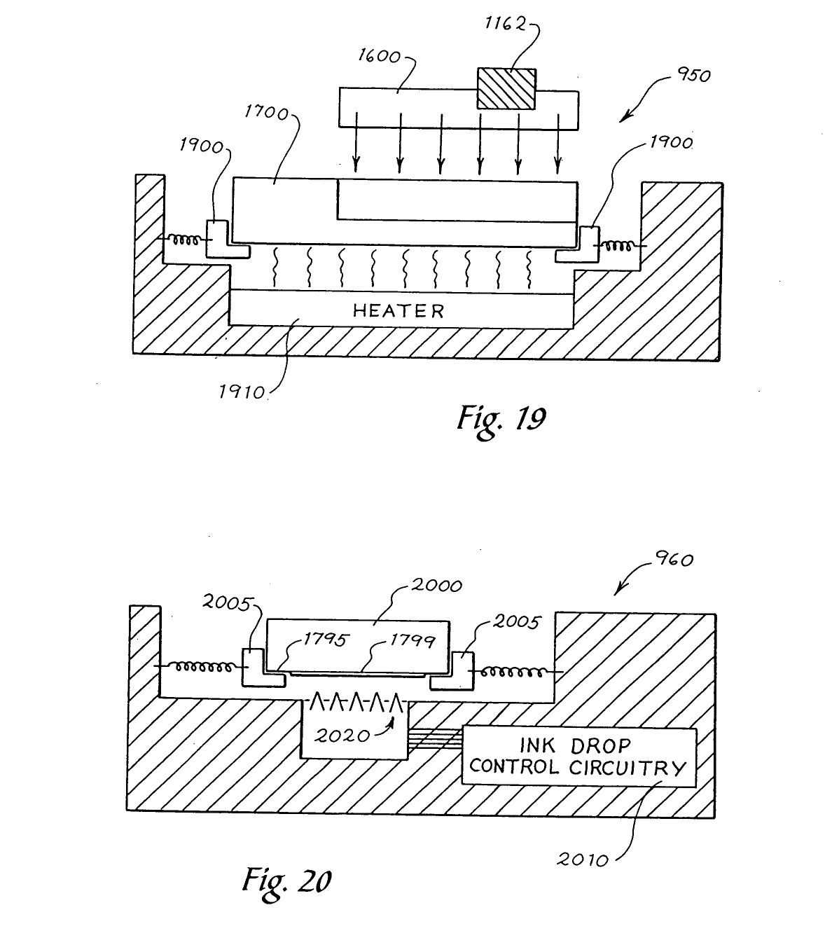

As shown in FIG. 20, after the final package shell 1700 is thermally set onto the interim package 1600 (thereby forming a final memory package 2000), the pickup head 1150 grabs the final memory package 2000 and positions it on a mount 2005 in the label station 960. The control circuitry of the video kiosk 100 then activates ink drop control circuitry 2010 to print a label 1799 (see FIG. 17b) on the underside 1795 of the final memory package 2000 using a plurality of ink nozzles 2020. The label 1799 can indicate, for example, the title and other information of the video content programmed into the memory device 2000, the date of programming, an advertisement, and/or user-customized information. The plurality of ink nozzles 2020 can print indicia directed on the final memory package 2000, or the label station 960 can first apply a blank label on the final memory package 2000 and then have the plurality of ink nozzles 2020 print indicia on that blank label. Also, in embodiments where it is desired to impede access to a high-speed programming port through the application of non-conductive ink, the plurality of ink nozzles 2020 can apply that ink. (If the label station 960 provides a physical label that attaches to the memory device, the physical label could be used to impede access to the high-speed programming port.)

Before or after the final memory package 2000 is delivered to the label station 960, the pickup head 1150 can plug the final memory package 2000 into an appropriately-sized slot in the plurality of slots 1870 in the programming station 940. Each slot comprises contacts that can mate with the user port of a final memory package, and the read/write electronics 1880 can perform verification of the programmed video content and/or store additional information in the memory array.

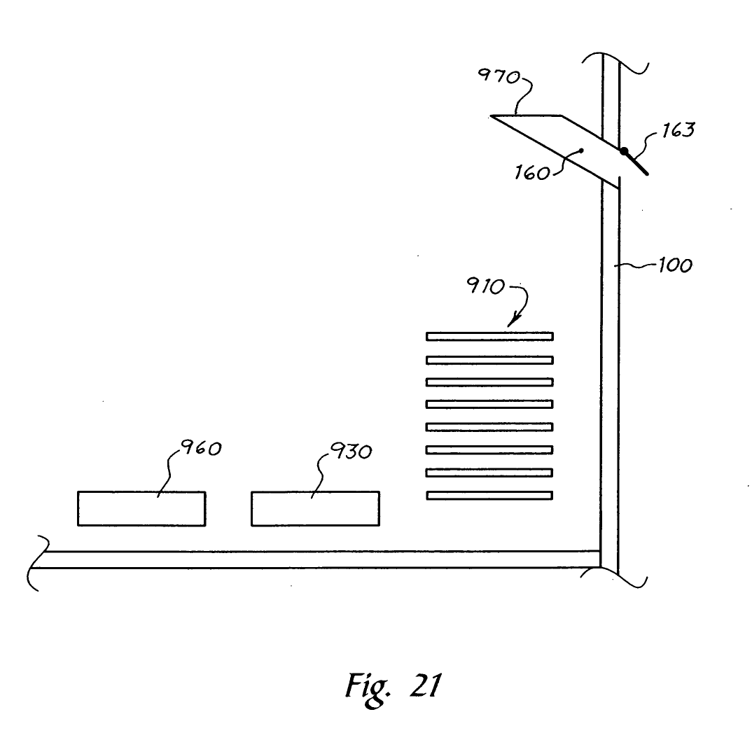

When the final memory package 2000 is ready to be delivered to the end user, the arm 1100 raises the pickup head 1150 to position the final memory package 2000 above the opening 970 of the chute 160 (see the diagrammatic illustration in FIG. 21). When the pickup head 1150 releases its grip, the final memory package 2000 drops through the opening and slides down the chute 160, where it can be picked-up by the user by opening the swinging door 163.

There are many alternatives that can be used with these embodiments. For example, many alternative structures can be used for the transport mechanism. In one alternate embodiment, instead of using a movable carriage, a rotating arm is used, and the various processing stations are located in a circle along the circumference defined by the radius of the rotating arm. In yet another alternate embodiment, multiple arms are used, instead of the single arm described above. Irrespective of the transport mechanism used, one or more of the processing stations can have its own system for moving a part. For example, the label station can have a conveyor belt to move a memory device from a label-feed-and-application sub-station to an ink-jet-printer-head sub-station. Further, as indicated above, each processing station can have a different configuration than the configuration presented herein (e.g., the final package station can use only pressure instead of heat to combine an interim package and outer package shell), and fewer or more processing stations can be used. As yet another example, in embodiments where the video kiosk comprises a memory device input, which allows a user to supply his own memory device to the video kiosk, the memory device input can merely be an exposed port that couples with a port on the user-supplied memory device, or the memory device input port can receive a memory device and provide it to the video kiosk's internal transport mechanism for movement among various processing stations in the video kiosk. As can be seen from these exemplary alternatives, the embodiments described above are merely for illustration purposes, and many alternatives can be used. Accordingly, the details presented herein should not be read into the claims unless explicitly recited therein.

### Exemplary Security Aspects of a Video Kiosk

While video content can be stored in the video kiosk 100 and programmed into a memory device in an unprotected form, it may be preferred to equip the video kiosk 100 with a security system to ensure that video content is stored securely both in the video kiosk 100 and in the programmed memory device. With such a security system in place to prevent unauthorized copies, studios and other video content owners may be more likely to allow their video content to be locally-loaded onto a removable solid-state memory device by the video kiosk 100. The following paragraphs provide examples of various types of security mechanisms that can be used. Of course, other types of security mechanisms can be used, and any of these security embodiments can be used alone or in combination with the other embodiments described herein.

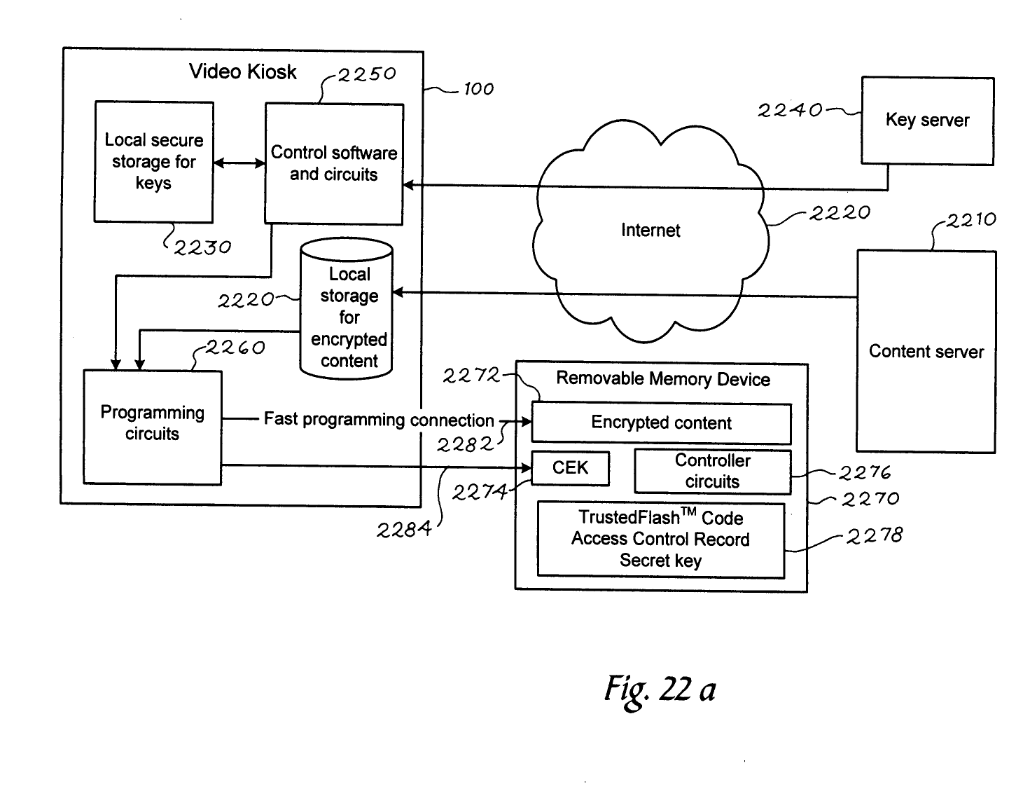

Returning to the drawings, FIG. 22a is a diagram that illustrates various security aspects relating to the video kiosk 100. As shown in FIG. 22a, the video kiosk 100 in this embodiment comprises a local mass storage device 2200 (such as a hard disk drive (“HDD”)) that stores video content in an encrypted form. Although a single local mass storage device 2200 is shown in FIG. 22a, it should be understood that the video kiosk 100 can comprise a plurality of local mass storage devices. The encrypted video content can be supplied to the local mass storage device 2200 in any suitable way. For example, through one of its plurality of ports 180 (see FIG. 1b), the video kiosk 100 can communicate with a content server 2210 via the Internet 2220 (or other network) and download the encrypted video content. Because the video content is encrypted, a normal (i.e., unsecured) connection can be used. In an alternate embodiment, the content server 2210 can send un-encrypted video content to the video kiosk 100 over a secure connection, and circuitry in the video kiosk 100 can encrypt the video content and store the encrypted video content in the local mass storage device 2200.

The transfer of video content from the content server 2210 to the video kiosk 100 can take place at any time. For example, the video kiosk 100 can make regular connection to the content server 2210 to download video content, so that video content is stored in the local mass storage device 2200 prior to a user selecting the video content via the video kiosk's user interface. Alternatively, if the local mass storage device 2200 does not have a video title desired by a user, the video kiosk 100 can contact the content server 2210 on-the-fly to download the desired video content. Preferably, the connection between the video kiosk 100 and the content server 2210 is suitably fast (e.g., at a broadband connection speed), so the user does not have to wait too long for the downloading to be complete. As yet another alternative, instead of pre-downloading video content or downloading video content on-the-fly, a service technician at the physical location of the video kiosk 100 can upload video content to the local mass storage device 2200 (e.g., by using a laptop computer connected to one of the plurality of ports 180) or by swapping out the local mass storage device 2200 in the video kiosk 100 with another local mass storage device that contains new video content.

The video kiosk 100 also comprises a local secure storage device 2230 that stores the keys (e.g., “content encryption keys” or “CEKs”) needed to decrypt the encrypted video content stored in the local mass storage device 2200. Although the local secure storage 2230 is separate from the local mass storage device 2200 in this embodiment, the local secure storage 2230 device can be part of the local mass storage device 2200. In this embodiment, the keys are downloaded from a key server 2240 accessible via the Internet 2220 using a secure transmission protocol (a “secure channel”) to prevent someone from gaining unauthorized access to the transmitted keys. While a secure transmission is generally slower than an un-secure transmission because of the security protocols involved, because the keys contain a limited about of data, the delays imposed by the security protocols should not be that noticeable by the user. As with encrypted video content, the video kiosk 100 can download the keys before or in response to a selection of video content by a user, and the keys can be locally delivered by a service technician instead of downloaded over a network.

As shown in FIG. 22a, the video kiosk 100 has control software and circuits 2250 that securely store keys received from the key server 2240 in the local secure storage 2230. The control software and circuits 2250 are preferably designed to prevent unauthorized read access to the stored keys via the Internet connection or via one of the plurality of ports 180 of the video kiosk 100. Preferably, the control software and circuits 2250 are an integral part of the local secure storage 2230, so an unauthorized user cannot gain access to the keys even if he has physically access to the local secure storage 2230. With such security measures in place, the encrypted video content cannot be decrypted and used without proper authorization. As an added security measure, instead of storing keys on the local secure storage 2230 prior to receiving a request for the associated video content, the appropriate key can be downloaded from the key server 2240 on-the-fly when a user makes the request.

Although any number of keys can be used, it is presently preferred that there be one key for each video content title stored in the local mass storage device 2200. Instead of all of the encrypted copies of a given video title having the same encryption key, a key can be periodically changed, and the encrypted video content on the content server 2210 can be revised accordingly. In this situation, it may be preferred to download the key from the key server 2240 when the encrypted video content is downloaded from the content server 2210 to keep synchronization between the key and the encrypted video content file. Alternatively, the control software and circuits 2250 in the video kiosk 100 can re-encrypt the video content stored in the local storage 2200 with the new key.

Returning to FIG. 22a, the video kiosk 100 also comprises programming circuits 2260 to program encrypted video content and associated keys into a removable solid-state memory device 2270. (Although it is presently preferred that a single memory IC in the memory device contain both the encrypted video content and the keys, two (or more) memory ICs can be used: one for the encrypted video content and one for the keys.) As shown in FIG. 22a, it is preferred that the encrypted video content 2272 be programmed in the removable memory device 2200 using a fast programming connection because of the relatively-large file size of the encrypted video content 2272. As discussed in the embodiments above, the fast programming connection can be provided using a relatively high-speed programming port that is separate from a lower-complexity, easier-to-drive user port of the removable memory device 2270. To further reduce programming time, the encrypted video content 2272 can be in a compressed form.

The programming circuits 2260 also program the associated content encryption key (“CEK”) 2274 for the encrypted video content 2272 into the removable memory device 2270 (preferably also using the fast programming connection or, alternatively, using a slower-connection port). Preferably, the programming circuits 2260 program the CEK 2274 into the removable memory device 2270 using a secure mechanism so the CEK 2274 cannot be intercepted during the transfer. Since the CEK 2272 comprises only a relatively limited amount of data, the delay caused by using a secure transfer mechanism should not be that noticeable to the user.

In one embodiment, the controller circuits 2276 also comprise a decryption engine to decrypt the encrypted video content 2272 using the CEK 2274 and provide the decrypted data to a playback device at a speed sufficient for user enjoyment of the video content. This speed generally requires a much slower connection than the fast programming connection used to program the video content in the memory device 2270 (e.g., the speed needed to provide “real time” playback of the video content from the memory device 2270). Accordingly, as discussed above, in one embodiment, the memory device 2270 comprises two ports: (1) a high-speed programming port (e.g., a DDR2 interface that can provide a write speed of about 500 MB/sec or more) used to provide a fast programming connection and (2) a conventional, easy-to-drive user port, such as an SD port in communication with a page-based NAND Flash interface, to provide a data rate of about 5-20 MB/sec. As also mentioned above, if desired, user access to the high-speed programming port can be impeded (e.g., using non-conductive ink, a label, or an outer package shell), or a memory device with a dual-use port (e.g., a PCI express interface) can be used.

There are several alternatives that can be used with these embodiments. For example, while a decryption engine is relatively low-cost circuitry, some memory devices may not be equipped with a built-in decryption engine. In this alternative, the memory device can output the encrypted video content and the associated CEK to a video playback device for decryption. However, it is preferred that the CEK be transferred to the video playback device using a secure channel and that the video playback device authenticate itself to the memory device as a device that can be trusted with the CEK. In another alternative, which will be described in more detail below, the security system on the memory device can allow the transfer of the encrypted video content without the associated CEK. Consider, for example, the situation in which a first user purchases a video title and has both the encrypted video content and the associated CEK on his memory device. This first user could copy the encrypted video content from his memory device onto a second user's memory device. A later time, the second user could enable that video content by interacting with another kiosk (or other device connected to the key server) to download the associated CEK. Additionally, selected copies can be made and controlled from the first user's copy, with or without assessing a fee. For example, the first user could be allowed to make (or “check-out”) lower-resolution copies of the video from the “master copy” on his memory device. In yet another alternative, the video kiosk can program the encrypted video content—but not the CEK—into a memory device, and the memory device can be delivered to the user before payment of the video content/memory device is arranged. Without the CEK, the user cannot view the video content, so he would not have an incentive to take the memory device from the store without paying for it. At a separate kiosk or programming station, preferably at the checkout area of the store, a store employee can receive payment from the user and program the CEK in the memory device. (In an alternative embodiment, the user uses the video kiosk merely to make a video selection and picks up the programmed memory device from the checkout area of the store.)

In yet another alternative, to provide an even more robust security system, video content stored in the video kiosk 100 can be encrypted differently from the video content stored in the removable memory device (instead of using the same key, as in the above embodiments). In operation, when the memory device receives the encrypted video content and key from the video kiosk 100, the memory device can decrypt the video content using the key and then re-encrypt the video content on-the-fly with a separate key stored in the memory device. However, if a memory device has processing power limitations, it may not be able to perform decryption and re-encryption in real time while still achieving a desired high data rate (e.g., 500 MB/sec).

### Exemplary Security Aspects Using TrustedFlash™ Removable Storage

While a variety of suitable security mechanisms can be used, it is presently preferred that the removable memory device 2270 of FIG. 22a take the form of a TrustedFlash™ memory device from SanDisk Corporation and that the security mechanisms operate in accordance with TrustedFlash™ protocols. Further information about TrustedFlash™ can be found in U.S. patent application Ser. Nos. 11/314,411 (published as U.S. patent publication 2006/0242068A1), 11/557,028, and 11/322,812 (published as U.S. patent publication 2007/0043667A1), which are hereby incorporated by reference. Furthermore, the memory device may include any combination of re-writable non-volatile memory or one-time programmable non-volatile memory. U.S. Pat. No. 7,062,602, which is hereby incorporated by reference, describes techniques suitable for making a one-time programmable memory behave like a re-writable non-volatile memory, the techniques being useful for both the content storage and/or for the control structures used by TrustedFlash™ devices. U.S. patent application Ser. No. 11/529,582, which is also hereby incorporated by reference, describes the combination of both rewritable memory and one-time programmable memory in the same device. Such a device can be used with these embodiments. For example, the rewritable memory can be used to add new keys to video stored in the one-time programmable memory (e.g., when the device is returned to a video store). The rewritable memory can also be used to add patches, such as headers or trailers, to OTP bulk storage.

In the TrustedFlash™ approach, the video content is encrypted and decrypted using a secure key (CEK) contained within the memory device and not accessible outside of it. The user interacts with the removable storage device by authenticating to the device and, when authenticated, a “system agent” within the device creates and manages the allowed user permissions to the content on a user-by-user basis and on a content-file-by-content-file basis (or group of files). In this case, the high-speed programming circuits 2260 of FIG. 22a transfer content directly to the memory device. FIG. 22b, adapted from the above-cited publications, shows the physical architecture of a suitable TrustedFlash™ memory device 2270′ in place of the previously described memory device 2270 of FIG. 22a. The host interface 26 is generalized to include both a high speed fast programming interface (2282 of FIG. 22a), which connects relatively directly to the Host DMA port 32 of the Buffer Management Unit (BMU 14) and from there through the crypto-engine 40 to the flash storage memory 20, and the standard interface (2284 of FIG. 22a) which is preferably used during authentication to access the ACR's in the manner described in the referenced applications.

The content from the kiosk can be either encrypted or not, but is preferably re-encrypted and stored using a CEK known only to the memory device. Prior to beginning the download, the kiosk authenticates to the memory device and establishes a file identification for the succeeding content. This interaction is controlled by an “Access Control Record” (ACR) or “Rights Object” (RO) created within the TrustedFlash™ device that associates the internal CEK with this file identification and initializes the internal encryption engine to perform encryption of the succeeding data using this CEK. As the data is transferred to the device, it is encrypted by the encryption engine and stored in an encrypted format in a restricted region of the memory device. (In one embodiment, the encryption engine is operative to keep up with the data transfer rate of the high-speed programming interface (e.g., the encryption can be 64-bit combinatorial encryption, which operates at a sub-multiple of the high-speed transfer clock rate).) In one embodiment, the kiosk can establish the specific rights associated with the current user who has purchased the content by creating an ACR for that user containing those specific rights which have been purchased. In another embodiment, the kiosk can identify the content, and an ACR containing the user rights associated with the content can be created at a subsequent step or location, for example at the checkout counter or even at the playback device. Such rights, as detailed in the applications cited above, can include the number of allowed accesses, the type of access (for example, preview, low-resolution playback, high-resolution playback, etc), type or serial number of allowed playback devices, the duration time period of accesses, etc.

When access to the stored content is desired, the user again authenticates to the memory device through the Access Control Record and identifies the content requested using the content identification assigned by the kiosk when loading the content. Depending on the access model and rights, the authentication can be highly restricted or widely open for anyone to access the content within the other allowed access parameters. In one embodiment, authentication may be automatic, and any playback machine can access the content through the user interface as long as any other restrictions of the Rights Object associated with the selected content file identification are met. In another embodiment, the content may only be accessed via a specific playback device. In this embodiment, the playback device (or another device accessible to the playback device at the time of playback) authenticates to the memory device. Included within the scope of this embodiment is the purchase of rights via an Internet connection to a Key Server such as 2240 of FIG. 22a at playback time in place of or in addition to those purchased at the time of loading the memory device with content by the kiosk. For example, a user could purchase a time or usage extension or could purchase the ability to render the content at a higher resolution than originally allowed.

### Exemplary Uses of a Video Kiosk

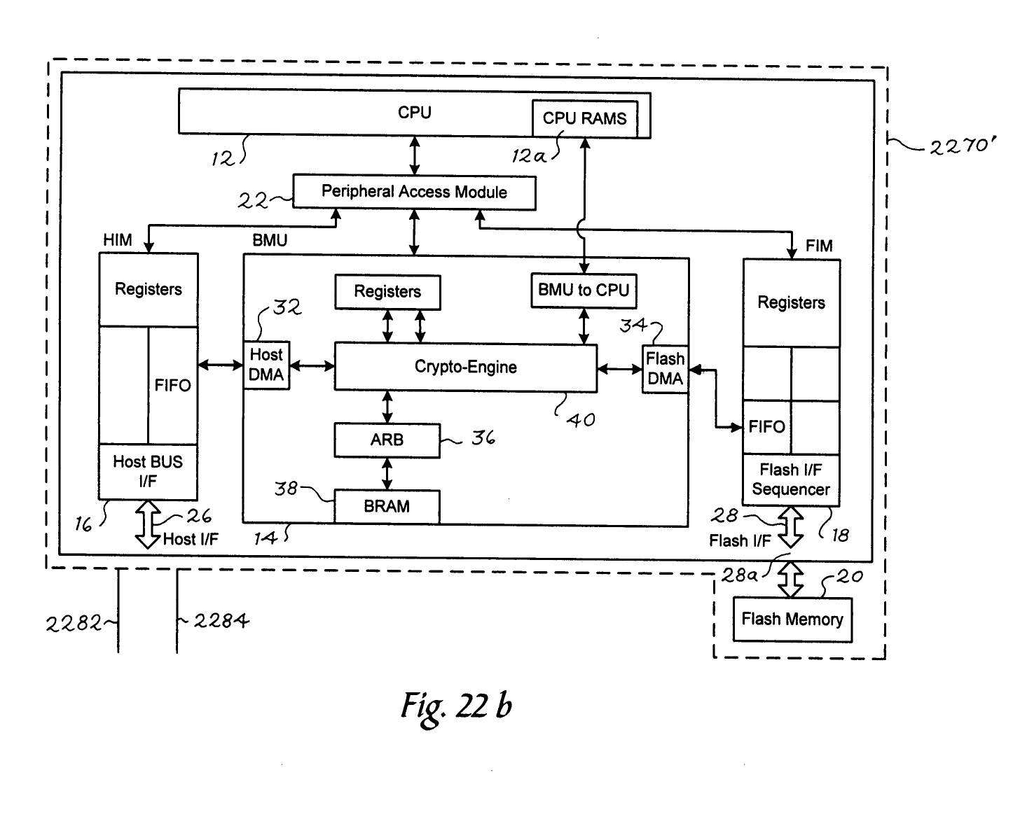

Turning again to the drawings, FIG. 23 is an illustration of various components that will be used to present exemplary uses of the video kiosk 100. As shown in FIG. 23, the video kiosk 100 comprises control program and electronics 2300 in communication with one or more storage devices 2310, a video touch screen 140, a payment device such as a credit card reader 150, and an Internet connection, which, in this embodiment, is one of the plurality of ports 180 (see FIGS. 1a and 1b). As used herein, the phrase “in communication with” means directly in communication with (e.g., through a wired or wireless connection) or indirectly in communication with through one or more components, which may or may not be shown or described herein. Also, the control program and electronics 2300 shown in FIG. 23 can include the control software and circuits 2250 shown in FIG. 22a, as well as the “controller” and “circuitry” referenced above in several of the embodiments. As mentioned above, the term “circuitry” (or “circuit”) may be used herein or in the claims to generally refer to the hardware and/or software components used to implement various functionality. Also, the storage device 2310 shown in FIG. 23 can include the local storage 2200 and the local secure store 2230 shown in FIG. 22a, as well as other storage devices of the video kiosk 100.

In this embodiment, the control program and electronics 2300 display movie trailers or advertisements on the video touch screen 140 while waiting for an active user. These trailers or advertisements can be stored in the storage device 2310 or can be downloaded from the Internet or other network location. When a user touches the screen 140, the control program and electronics 2300 display a graphical user interface, which can include, for example, an options menu including an option to acquire the video content that was just shown on the screen, an option to view a menu of similar video titles, and an option to search for video content based on movie type, movie name, actors, etc. Using these or other menus, the user can indicate a video selection choice by touching the desired title displayed on the touch screen display 140. Alternatively, the user can use the key pad 145 or some other user interface element on or in communication with the video kiosk 100 to make the selection (e.g., a track ball, microphone, stylus, remote control device, etc.).

As another alternative, the control program and electronics 2300 can present a user with a log-in screen. After the user logs-in to the video kiosk 100, the control program and electronics 2300 can retrieve the user's record from the storage device 2310 or from data servers accessible over the Internet. The user's record can contain, for example, user profile information, preference data, information on prior video selections, recommended video selections, “wish list” video selections, account information, and payment transaction verification. Account information, “wish list” video selections, and other information in the record can be updated by the user at the video kiosk 100, at another video kiosk, or on-line using a computer or other device. Based on the user's record, the control program and electronics 2300 can automatically select video content for the user or can present a list of recommendations. “Method for Field-Programming a Solid-State Memory Device with a Digital Media File,” U.S. patent application Ser. No. 09/823,489, filed Mar. 30, 2001, which is hereby incorporated by reference, describes various content selection embodiments and other embodiments that can be used with this and any other embodiment described herein.

Irrespective of the selection process, after video content is selected, the control program and electronics 2300 can display another screen presenting options for the quality level of the video content versus price, which can be updated based on the available media in the video kiosk 100 (as described in more detail below). The control program and electronics 2300 can then present a payment screen to facilitate the purchase of the video content and removable memory device. Payment can be made either through the payment device 150 on the video kiosk 150, or the cost of the video content can be deducted from the user's account or automatically charged to a credit card on file in the user's record. After the user confirms the purchase, the control program and electronics 2300 initiate the media programming process described above. As the memory device is being programmed, the control program and electronics 2300 can display trailers of related video titles, advertisements, options to search and purchase other video content, and options to provide other services.

If the selected video content is stored in the local storage device 2310, the control program and electronics 2300 can begin programming the media device immediately. However, it is possible that the selected video content will not be stored in the local storage device 2310. For example, in one embodiment, the storage device 2310 stores trailers, advertisements, and frequently-requested video content, and if the selected video content is not among the stored frequently-requested video content, the control program and electronics 2300 can retrieve the selected video content from the video content servers accessible over the Internet (or other network). If downloading the video content will take a long time, the video kiosk 100 can display a message requesting the user to return in a time greater than the predicted download time for the requested video content.

As described above, in one embodiment, the video content is programmed into the memory device in an encrypted form, and the control program and electronics 2300 also program a decoding key (e.g., a content encoding key (“CEK”)) in the memory device. If programming the decoding key is the last step in the programming process, it may be preferred to wait until the key is programmed into the memory device before processing payment. Alternatively, the video kiosk's memory device delivery chute 160 (see FIG. 1a) can be equipped with a sensor to sense the delivery of a memory device, and payment processing can be delayed until the sensor senses that the memory device has been delivered to the user. In another alternative, the memory device delivered to the user can contain the encrypted video content but not the decrypting key, and the user is not charged until the user brings the memory device to a separate kiosk or programming station, preferably at the checkout area of the store, for a store employee to confirm payment and program the key in the memory device. In yet another alternative, instead of the video kiosk 100 delivering a programmed memory device to the user, the user could pick-up the programmed memory device at another location, such as at a checkout area at a store. In this alternative, the video kiosk 100 would serve as a video content selection device, and the actual programming of the memory device can occur either in the video kiosk 100 or at another location.

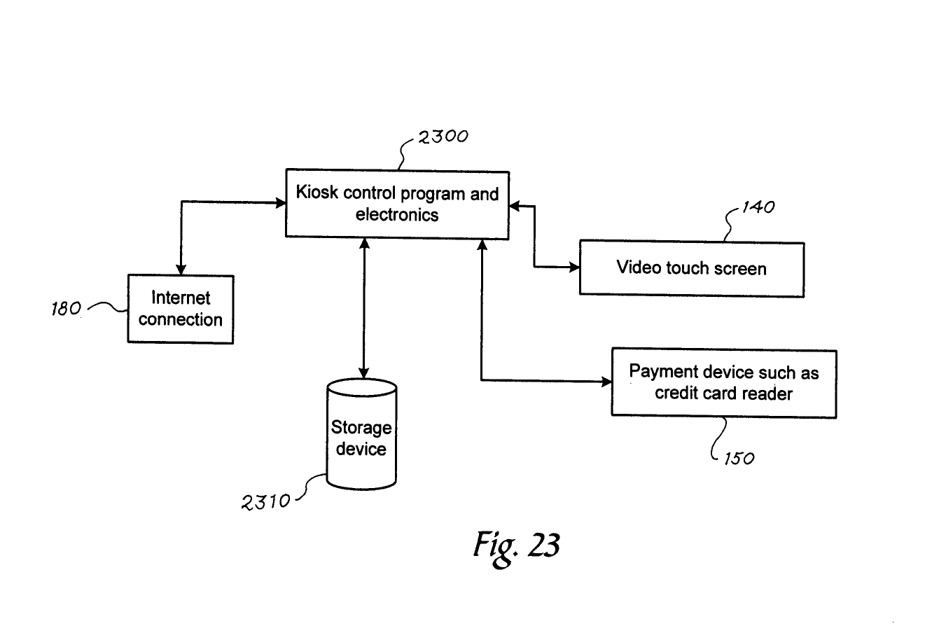

The control program and electronics 2300 can also contain sales delivery optimization algorithms to calculate available space on a to-be- (or already-) programmed memory device and can provide flexible on-the-fly-delivery of video content based on that calculation. For example, the control program and electronics 2300 can record additional features or delete features (with or without a price adjustment) to efficiently use a media capacity. These and other features will be described below with reference to FIGS. 24a-24e.

In the example shown in FIG. 24a, a user selected a “best quality” version of video content with extra features (e.g., deleted scenes, cast interviews, director commentary, etc.). However, the total file for this selection is larger than the available space on the memory device. After determining this problem, the control program and electronics 2300 can provide options to the user, such as removing some of the extra features. Turning now to the example shown in FIG. 24b, the control program and electronics 2300 can also determine that programming a memory device with the selected video content will result in unused space in the memory device. In this situation, the control program and electronics 2300 can suggest or automatically program a second video to fill the available space (see FIG. 24c). The control program and electronics 2300 can provide the user with incentives for making the additional purchase, such as offering the additional purchase at a discounted rate or providing a discount on the originally-selected video content if the additional purchase is made. If the user does not want to pay for the additional purchase, the control program and electronics 2300 can fill the unused space with free related trailers or other free content, such as advertisements. Additionally, instead of filling unused space with free or paid video content, the control program and electronics 2300 can fill unused space with non-video content, such as, but not limited to, audio files, text files, and games.

Also, as shown in FIG. 24d, if the memory device does not have the capacity to hold video content of a particular quality (e.g., best quality), the control program and electronics 2300 can offer a lower quality version (e.g., medium quality), so the selected video content fits in the memory device. (In FIG. 24d, programming a medium quality version of the video results in unused space in the memory device, and the unused space is filled with related trailers.) The control program and electronics 2300 can implement several variations of this concept. For example, if the video kiosk 100 stores different resolution versions of a given video and/or if the control program and electronics 2300 have a compression algorithm for programming video content at a variety of compression ratios, the control program and electronics 2300 can provide tier pricing of video content with different qualities (e.g., a high-definition version of a video can cost more that a DVD-quality version of the video, etc.). Since a higher-quality version of a video will likely take more time to program, the user can weigh the price, programming time, and video quality to determine which version of the video to purchase. Accordingly, the price of a video title can depend both on the title itself (e.g., newer releases being more expensive than older releases) and the quality of the video content (e.g., as chosen by the user or required by the memory capacity of the memory device).

As mentioned above, the control program and electronics 2300 can be used to implement other business models. For example, the control program and electronics 2300 can pre-load extra features or additional video in an encrypted form without the CEK needed to access those features/videos. When the user later connects the memory device to his player, a message can be displayed indicating that additional content is available and providing instructions on how the user can purchase the key to enable use of the content. As another example, the message can be displayed on the video kiosk 100 or printed on the package of the memory device, so the user is informed of the option to purchase the key on-the-spot (at the video kiosk or at a checkout area in the store).

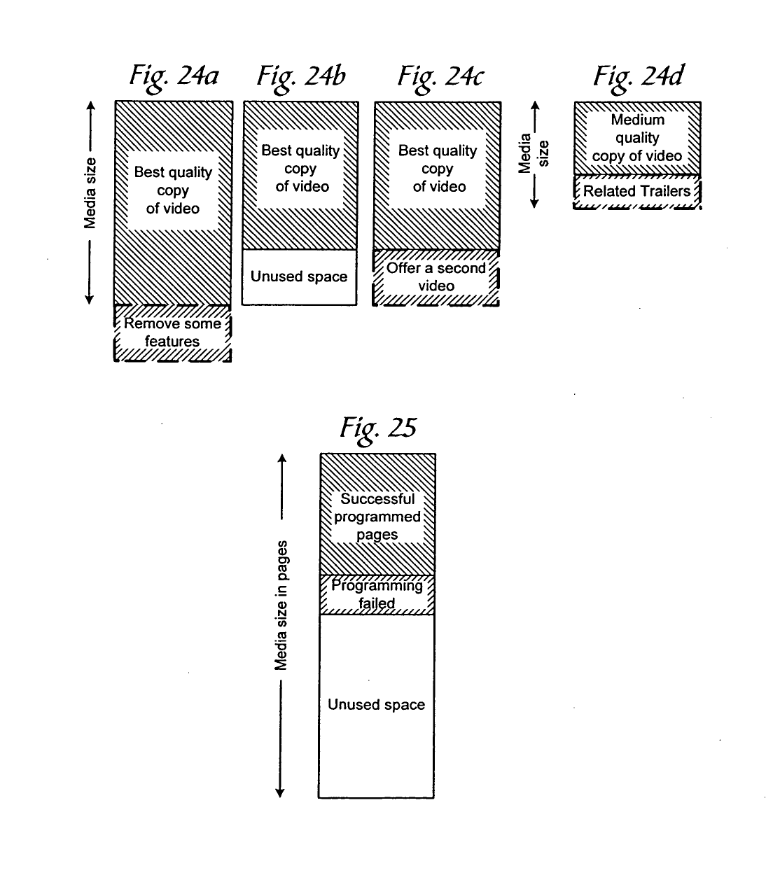

Returning again to the drawings, FIG. 25 illustrates a situation in which a programming or sales transaction cannot be completed by the video kiosk 100 because of a programming error (e.g., caused by a series of bad cell locations in a one-time programmable memory array). In this situation, the control program and electronics 2300 can institute a recovery method to salvage use of the partially-programmed memory device. For example, after the control program and electronics 2300 detects an error (e.g., after performing a read verify step after programming a page of information), the control program and electronics 2300 can attempt a programming recovery operation by using redundant cells in the page or a redundant page in the memory device. If that operation fails, the control program and electronics 2300 can use bad block replacement algorithms to attempt to re-program the page of data in a different location. U.S. Pat. Nos. 7,212,454 and 6,868,022 describe exemplary redundancy techniques and are hereby incorporated by reference.

The control program and electronics 2300 can track the rate of program fails and predict if the overall video content programming to the memory device will succeed or fail. If the control program and electronics 2300 predict failure and the memory device has enough room for a lower-quality version of the video content, the control program and electronics 2300 can offer the lower-quality version of the video content to the user at a discount. If the user accepts the offer, the control program and electronics 2300 program the lower-quality version of the video content into the memory device and deliver the memory device to the user. If the user declines the offer, the control program and electronics 2300 program the originally-selected video content onto a new memory device.

In one embodiment, the control program and electronics 2300 note the available space and partially-programmed state of a memory device (e.g., in a log in a storage area of the video kiosk 100) and places the memory device in the recycling tray 930 of the video kiosk 100 (see FIG. 9). (If a label for the video content was already printed on the memory device, the video kiosk 100 can contain a station to remove the paint/label.) The partially-programmed state can also be programmed into the memory device, as described in more detail below. When the video kiosk 100 later gets a request for video content, the control program and electronics 2300 can compare the size of the requested video content with the memory space available on the “recycled” memory devices in the recycling tray 930. (The recycling tray can also comprise memory devices that were partially-programmed at a factory or some other location external to the video kiosk 100 and then delivered for use as a partially-programmed memory device in the video kiosk 100). If there is a fit, the control program and electronics 2300 can use one of the “recycled” memory devices instead of a new memory device. The “recycled” nature of the memory device can be unknown to the user, or the control program and electronics 2300 can inform the user of the option of using a “recycled” memory device instead of a new memory device and perhaps even provide the user with a discount for taking the “recycled” memory device.

Also included within the scope of these embodiments is the re-use of previously programmed devices. As described earlier with respect to TrustedFlash™ devices, new rights can be easily applied for a new user, and a previously-used device can be added to the local kiosk inventory. In this case, only the Rights Object needs to be updated for the new user; no new content need be loaded, and the acquisition time for the user would be of the order of a few seconds, primarily limited by kiosk mechanical movement and credit card verification. As an incentive to acquire “used” memory devices, the kiosk owner may offer a discount or rebate when a user returns a previously-purchased memory device.

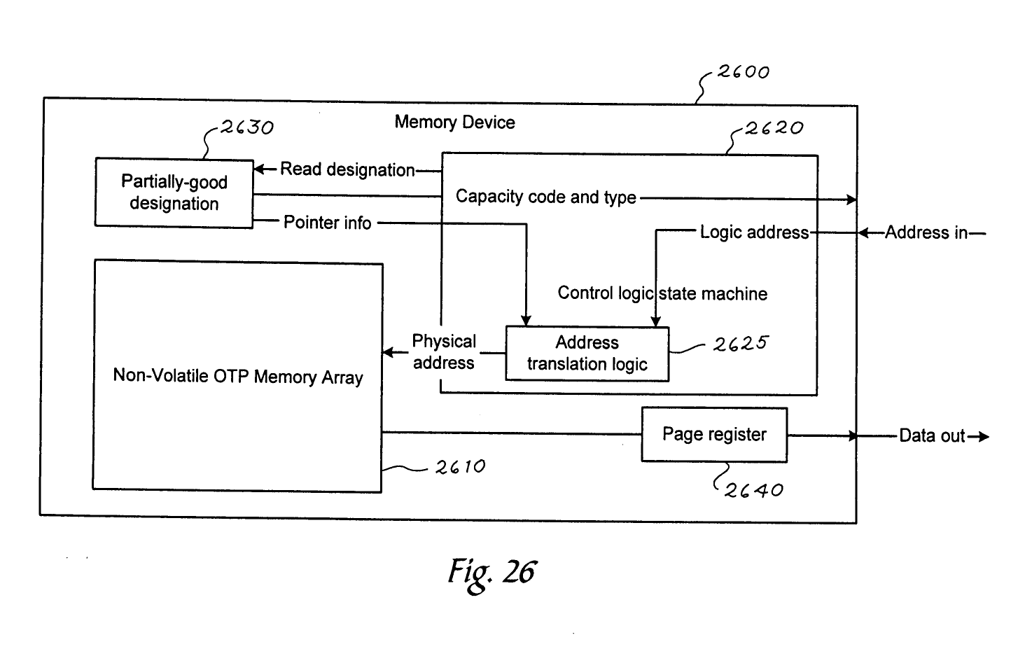

As mentioned above, the partially-programmed state of a memory device can be programmed into the memory device. This concept will be illustrated in conjunction with the memory device 2600 in FIG. 26. As shown in FIG. 26, the memory device 2600 in this embodiment comprises a memory array 2610 (here, a non-volatile one-time programmable memory array), a control logic state machine 2620, a memory 2630 (preferably comprising non-volatile memory cells) for storing a “partially-good designation,” and a page register 2640. In operation, when the control logic state machine 2620 attempts to program the memory array 2610 and encounters an uncorrectable error, the control logic state machine 2620 records the partially-good designation in the memory unit 2630. In one embodiment, the partially-good designation of the memory device 2600 indicates the memory device capacity, the “partially-good type,” and a pointer to the good or bad memory areas. Some examples of partially-good designations are shown in the following table:

| Capacity | Type | Pointer |
|---|---|---|
| 64 GB | All good | N/A |
| 32 GB | Half good | First half |
| 32 GB | Half good | Second half |
| 16 GB | Quarter good | First quarter |
| 16 GB | Quarter good | Second quarter |
| 16 GB | Quarter good | Third quarter |
| 16 GB | Quarter good | Fourth quarter |
| 48 GB | ¾ good | 1^{st}, 2^{nd}, 3^{rd} |
| 48 GB | ¾ good | 1^{st}, 2^{nd}, 4th |
| 48 GB | ¾ good | 1^{st}, 3^{rd}, 4^{th} |
| 48 GB | ¾ good | 2^{nd}, 3^{rd}, 4^{th} |
| 48 GB | ¾ good | All but two eighths |
| | | (e.g., 2^{nd}, 3^{rd}, 5^{th}, 6^{th}, 7^{th}, 8^{th}) |
| . . . | . . . | . . . |
| 56 GB | ⅞ good | All but 1^{st} eighth |

It should be noted that capacities do not have to be binary as shown in the table and that much larger capacities, which tend to increase with time, can be used. Further, a special page (such as page zero) can be used to hold manufacturing information and the partially-good designations. The partially-good designations could optionally be stored on chip in a separate, small memory cell array.

In operation, when the video kiosk 100 contacts the memory device 2600, the control logic state machine 2620 sends a read designation request to the memory 2630 for the partially-good designation. When the control logic state machine 2620 receives the capacity code and type, it sends that information to the video kiosk 100. If the video kiosk 100 chooses to use the memory device, it sends a logic address of a programming location. The control logic state machine 2620 uses address translation logic 2625 to translate this logical address into a physical address of the memory array 2610. Because the address translation logic 2625 receives pointer information from the partially-good designation, the address translation logic 2625 will provide translated physical addresses only for the good portions of the memory array 2610. A similar process occurs during read, with the page register 2640 being used to temporarily store data that will be outputted by the memory device 2600.

As mentioned above, it is preferred that the partially-good designation be stored in a non-volatile memory array of one-time programmable memory cells. Although the data in this memory 2620 will be updated as information about pointers and unused memory areas change, because the memory 2620 is one-time programmable, the original, unmodified data will still be present in the memory 2620 even after updated information is written. Preferably, pointers are used to point to the most-recent information about pointers and unused memory areas, as described in more detail in U.S. Pat. No. 7,062,602, which is hereby incorporated by reference. Additionally, firmware in the memory array 2610 can be updated using a similar mechanism.

There are many alternatives that can be used with these embodiments. For example, in addition to programming a key into the memory device, the video kiosk 100 can program a license that provides DRM restrictions for the video content (e.g., limited number of uses, time limitations, etc.). In this alternative, the memory device or player can contain functionality to validate the license. As there are many alternatives that can be used, details presented in these embodiments should not be read into the claims unless explicitly recited therein.

### CONCLUDING REMARKS

Many embodiments relating to digital content kiosks were described above. While “digital content” took the form of video content and the “digital content kiosk” took the form of a video kiosk in many of the above examples, it should again be noted that these are merely examples and other forms of digital content can be used. Accordingly, no specific form of digital content should be read into the claims unless explicitly recited therein. It is also important to again note that any of these embodiments can be used alone or in combination. For example, any of the exemplary security aspects discussed above can be used without or without any of the exemplary memory devices, architectures, and programming techniques discussed above.

Finally, it is intended that the foregoing detailed description be understood as an illustration of selected forms that the invention can take and not as a definition of the invention. It is only the following claims, including all equivalents, that are intended to define the scope of this invention. Also, some of the following claims may state that a component is operative to perform a certain function or configured for a certain task. It should be noted that these are not restrictive limitations. It should also be noted that the acts recited in the claims can be performed in any order—not necessarily in the order in which they are recited. Additionally, any aspect of any of the preferred embodiments described herein can be used alone or in combination with one another.

What is claimed is:

1. A method for using a digital content kiosk to program digital content, the method comprising:
with a digital content kiosk:
receiving a selection of digital content;
establishing communication with a memory device comprising a solid-state memory array, a relatively high-speed programming port in communication with the solid-state memory array, and a relatively low-speed user port in communication with the solid-state memory array; and
programming the digital content into the solid-state memory array of the memory device via the relatively high-speed programming port of the memory device.

2. The method of claim 1 further comprising:
with the digital content kiosk, supplying programming voltage to the memory device.

3. The method of claim 1 further comprising:
with the digital content kiosk, cooling the memory device while the digital content is being programmed into the solid-state memory array.

4. The method of claim 1 further comprising:
with the digital content kiosk, impeding access to the relatively high-speed programming port after programming the digital content into the solid-state memory array.

5. The method of claim 4, wherein impeding access to the relatively high-speed programming port comprises, with the digital content kiosk, spraying the relatively high-speed programming port with non-conductive ink.

6. The method of claim 1 further comprising:
with the digital content kiosk, obtaining the memory device from a storage location in the digital content kiosk.

7. The method of claim 1 further comprising:
with the digital content kiosk, receiving the memory device from a user providing the selection of the digital content.

8. The method of claim 1, wherein the relatively high-speed programming port and the relatively low-speed user port are different physical ports on the memory device.

9. The method of claim 1, wherein the relatively high-speed programming port and the relatively low-speed user port are integrated in a dual-use port on the memory device.

10. The method of claim 1, wherein the solid-state memory array comprises a three-dimensional memory array comprising a plurality of memory cell layers stacked vertically above one another above a single silicon substrate.

11. The method of claim 1, wherein the solid-state memory array comprises a plurality of memory cells comprising a diode and a switchable-resistance material.

12. The method of claim 1, wherein the memory device further comprises:
high-speed input circuitry between the relatively high-speed programming port and the solid-state memory array; and
NAND flash interface control circuitry between the relatively low-speed user port and the solid-state memory array.

13. A method for programming digital content using a digital content kiosk, the method comprising:
with a digital content kiosk:
receiving a selection of digital content;
establishing communication with an interim package comprising a solid-state memory array, a relatively high-speed programming port in communication with the solid-state memory array, and a relatively low-speed user port in communication with the solid-state memory array;
programming the digital content into the solid-state memory array of the interim package via the relatively high-speed programming port; and
combining the interim package with an outer package shell.

14. The method of claim 13 further comprising:
with the digital content kiosk, supplying programming voltage to the interim package.

15. The method of claim 13 further comprising:
with the digital content kiosk, cooling the interim package while the digital content is being programmed into the solid-state memory array.

16. The method of claim 13, wherein the outer package shell is configured to expose the relatively low-speed user port but not the relatively high-speed programming port when the outer package shell is combined with the interim package.

17. The method of claim 13, wherein the solid-state memory array comprises a three-dimensional memory array comprising a plurality of memory cell layers stacked vertically above one another above a single silicon substrate.

18. The method of claim 13, wherein the solid-state memory array comprises a plurality of memory cells comprising a diode and a switchable-resistance material.

19. The method of claim 13, wherein the interim package further comprises:
high-speed input circuitry between the relatively high-speed programming port and the solid-state memory array; and
NAND flash interface control circuitry between the relatively low-speed user port and the solid-state memory array.

20. The method of claim 13, wherein the relatively high-speed programming port and the relatively low-speed user port are different physical ports on the interim package.

21. The method of claim 13, wherein the relatively high-speed programming port and the relatively low-speed user port are integrated in a dual-use port on the interim package.

22. A method for programming digital content using a digital content kiosk, the method comprising:
with a digital content kiosk:
receiving a selection of digital content;
establishing communication with an interim package comprising:
a solid-state memory array comprising a three-dimensional memory array comprising a plurality of memory cell layers stacked vertically above one another above a single silicon substrate, wherein the memory cell layers comprise one-time programmable memory cells;
a relatively high-speed programming port in communication with the solid-state memory array; and
a relatively low-speed user port in communication with the solid-state memory array;
supplying programming voltage to the interim package;
programming the digital content into the solid-state memory array of the interim package via the relatively high-speed programming port;
cooling the interim package while the digital content is being programmed into the solid-state memory array; and
combining the interim package with an outer package shell, wherein the outer package shell exposes the relatively low-speed user port but not the relatively high-speed programming port.

23. The method of claim 22, wherein the interim package further comprises:
high-speed input circuitry between the relatively high-speed programming port and the solid-state memory array; and
NAND flash interface control circuitry between the relatively low-speed user port and the solid-state memory array.

24. The method of claim 22, wherein the interim package comprises circuitry operative to program digital content received from the digital content kiosk in a distributed manner in the solid-state memory array.

25. The method of claim 24, wherein the solid-state memory array is organized into a plurality of sub-arrays, and wherein the circuitry is operative to program digital content received from the digital content kiosk in a distributed manner among the plurality of sub-arrays.

26. A memory device suitable for use in a digital content kiosk, the memory device comprising:
a solid-state memory array;
a relatively high-speed programming port in communication with the solid-state memory array, wherein the relatively high-speed programming port is configured to receive digital content from a mating programming port in a digital content kiosk; and
a relatively low-speed user port in communication with the solid-state memory array, wherein the relatively low-speed user port is configured to provide read access to digital content programmed in the solid-state memory array.

27. The memory device of claim 26 further comprising:
an input for receiving programming voltage from a digital content kiosk.

28. The memory device of claim 26, wherein the relatively high-speed programming port and the relatively low-speed user port are different physical ports on the memory device.

29. The memory device of claim 26, wherein the relatively high-speed programming port and the relatively low-speed user port are integrated in a dual-use port on the memory device.

30. The memory device of claim 26, wherein the relatively high-speed programming port comprises a DDR2 interface.

31. The memory device of claim 26, wherein the relatively high-speed programming port comprises a PCI Express interface.

32. The memory device of claim 26, wherein the relatively low-speed user port comprises an SD port.

33. The memory device of claim 26, wherein the solid-state memory array comprises a three-dimensional memory array comprising a plurality of memory cell layers stacked vertically above one another above a single silicon substrate.

34. The memory device of claim 26, wherein the solid-state memory array comprises a plurality of memory cells comprising a diode and a switchable-resistance material.

35. The memory device of claim 26 further comprising:
circuitry operative to program digital content received from a digital content kiosk in a distributed manner in the solid-state memory array.

36. The memory device of claim 35, wherein the solid-state memory array is organized into a plurality of sub-arrays, and wherein the circuitry is operative to distribute the digital content among the plurality of sub-arrays.

37. The memory device of claim 26 further comprising:
a temperature sensor; and
circuitry operative to control programming of digital content received from a digital content kiosk based on a temperature sensed by the temperature sensor.

38. The memory device of claim 37, wherein the circuitry is operative to delay a programming operation based on the temperature sensed by the temperature sensor.

39. The memory device of claim 37, wherein the solid-state memory array is organized into a plurality of sub-arrays, and wherein the circuitry is operative to select a number of sub-arrays to be programmed based on the temperature sensed by the temperature sensor.

40. The memory device of claim 26, wherein the solid-state memory array, relatively high-speed programming port, and relatively low-speed user port are provided on an interim package configured to be combined with an outer package shell.

41. The memory device of claim 26 further comprising:
an outer package shell enclosing the solid-state memory array and exposing the relatively high-speed programming port and the relatively low-speed user port.

42. A memory device suitable for use in a digital content kiosk, the memory device comprising:
a solid-state memory array comprising a three-dimensional memory array comprising a plurality of memory cell layers stacked vertically above one another above a single silicon substrate, wherein the memory cell layers comprise one-time programmable memory cells, and wherein the solid-state memory array is organized into a plurality of sub-arrays;
a relatively high-speed programming port in communication with the solid-state memory array, wherein the relatively high-speed programming port is configured to receive digital content from a mating programming port in a digital content kiosk;
a relatively low-speed user port in communication with the solid-state memory array, wherein the relatively low-speed user port is configured to provide read access to digital content programmed in the solid-state memory array;
an input for receiving programming voltage from a digital content kiosk; and
circuitry operative to program digital content received from a digital content kiosk in a distributed manner among the plurality of sub-arrays.

43. The memory device of claim 42, wherein the relatively high-speed programming port and the relatively low-speed user port are different physical ports on the memory device.

44. The memory device of claim 42, wherein the relatively high-speed programming port and the relatively low-speed user port are integrated in a dual-use port on the memory device.

45. The memory device of claim 42, wherein the relatively high-speed programming port comprises a DDR2 interface.

46. The memory device of claim 42, wherein the relatively high-speed programming port comprises a PCI Express interface.

47. The memory device of claim 42, wherein the relatively low-speed user port comprises an SD port.

48. The memory device of claim 42 further comprising:
a temperature sensor; and
second circuitry operative to control programming of digital content received from a digital content kiosk based on a temperature sensed by the temperature sensor.

49. The memory device of claim 48, wherein the solid-state memory array, relatively high-speed programming port, and relatively low-speed user port are provided on an interim package configured to be combined with an outer package shell.

50. The memory device of claim 42 further comprising:
an outer package shell enclosing the solid-state memory array and exposing the relatively high-speed programming port and the relatively low-speed user port.

51. A digital content kiosk comprising:
a storage area storing a plurality of memory devices, each memory device comprising a respective solid-state memory array, relatively high-speed programming port in communication with the solid-state memory array, and relatively low-speed user port in communication with the solid-state memory array;
a programming port; and
a transport mechanism configured to obtain a memory device from the storage area and place the relatively high-speed programming port of the memory device in communication with the programming port.

52. The digital content kiosk of claim 51 further comprising:
a connector configured to provide programming voltage to the memory device.

53. The digital content kiosk of claim 51 further comprising:
a cooling system configured to cool a memory device connected to the programming port.

54. The digital content kiosk of claim 53, wherein the cooling system comprises a fan.

55. The digital content kiosk of claim 53, wherein the cooling system comprises a cooling plate.

56. The digital content kiosk of claim 51 further comprising:
a label station operative to print a label on the memory device.

57. The digital content kiosk of claim 56, wherein the label station is further operative to spray the relatively high-speed programming port with non-conductive ink.

58. The digital content kiosk of claim 51, wherein the relatively high-speed programming port and the relatively low-speed user port are different physical ports.

59. The digital content kiosk of claim 51, wherein the relatively high-speed programming port and the relatively low-speed user port are integrated in a dual-use port.

60. The digital content kiosk of claim 51, wherein the solid-state memory array comprises a three-dimensional memory array comprising a plurality of memory cell layers stacked vertically above one another above a single silicon substrate.

61. The digital content kiosk of claim 51, wherein the solid-state memory array comprises a plurality of memory cells comprising a diode and a switchable-resistance material.

62. A digital content kiosk comprising:
a first storage area storing a plurality of interim packages, each interim package comprising a respective solid-state memory array, relatively high-speed programming port in communication with the solid-state memory array, and relatively low-speed user port in communication with the solid-state memory array;
a second storage area storing a plurality of outer package shells shaped to be combined with the plurality of interim packages;
a programming port;
a final package station; and
a transport mechanism operative to:
obtain an interim package from the first storage area and place the relatively high-speed programming port of the interim package in communication with the programming port;
transport the interim package from the programming port to the final package station; and
obtain an outer package shell and transport it to the final package station;
wherein the final package station is operative to combine the interim package and the outer package shell to form a memory device in a final package, and wherein the transport mechanism is further operative to transport the memory device in the final package to a delivery location.

63. The digital content kiosk of claim 62, wherein at least one of the interim package and the outer package shell comprises a thermally-settable adhesive, and wherein the final package station is operative to combine the interim package and the outer package shell by heating the thermally-settable adhesive.

64. The digital content kiosk of claim 62 further comprising:
a label station operative to print a label on at least one of the interim package and the outer package shell.

65. The digital content kiosk of claim 62 further comprising:
a connector configured to provide programming voltage to the interim package.

66. The digital content kiosk of claim 62 further comprising:
a cooling system configured to cool an interim package connected to the programming port.

67. The digital content kiosk of claim 66, wherein the cooling system comprises a fan.

68. The digital content kiosk of claim 66, wherein the cooling system comprises a cooling plate.

69. The digital content kiosk of claim 62, wherein the relatively high-speed programming port and the relatively low-speed user port are different physical ports.

70. The digital content kiosk of claim 62, wherein the relatively high-speed programming port and the relatively low-speed user port are integrated in a dual-use port.

71. The digital content kiosk of claim 62, wherein the solid-state memory array comprises a three-dimensional memory array comprising a plurality of memory cell layers stacked vertically above one another above a single silicon substrate.

72. The digital content kiosk of claim 62, wherein the solid-state memory array comprises a plurality of memory cells comprising a diode and a switchable-resistance material.

73. A digital content kiosk comprising:
a first storage area storing a plurality of interim packages, each interim package comprising:
a respective solid-state memory array comprising a three-dimensional memory array comprising a plurality of memory cell layers stacked vertically above one another above a single silicon substrate, wherein the memory cell layers comprise one-time programmable memory cells;
a respective relatively high-speed programming port in communication with the solid-state memory array; and
a respective relatively low-speed user port in communication with the solid-state memory array;
a second storage area storing a plurality of outer package shells shaped to be combined with the plurality of interim packages;
a programming port;
a final package station; and
a transport mechanism operative to:
obtain an interim package from the first storage area and place the relatively high-speed programming port of the interim package in communication with the programming port;
transport the interim package from the programming port to the final package station; and
obtain an outer package shell and transport it to the final package station;
wherein the final package station is operative to combine the interim package and the outer package shell to form a memory device in a final package, and wherein the transport mechanism is further operative to transport the memory device in the final package to a delivery location.

74. The digital content kiosk of claim 73 further comprising:
a connector configured to provide programming voltage to the interim package.

75. The digital content kiosk of claim 73 further comprising:
a cooling system configured to cool an interim package connected to the programming port.

76. A digital content kiosk comprising:
a user interface operative to receive a selection of digital content from a user;
a storage area storing a plurality of memory devices, each memory device comprising a respective solid-state memory array;
a programming port operative to program digital content into a solid-state memory array of a memory device; and
a transport mechanism operative to obtain a memory device from the storage area and transport is to the programming port; and
circuitry operative to control operation of the user interface, programming port, and transport mechanism.

77. The digital content kiosk of claim 76 further comprising:
a label station operative to print a label on a memory device.

78. The digital content kiosk of claim 76 further comprising:
a payment input device.

79. The digital content kiosk of claim 76 further comprising:
a connector operative to connect the digital content kiosk with a network.

80. The digital content kiosk of claim 76, wherein each memory device comprises a respective solid-state memory array, relatively high-speed programming port in communication with the solid-state memory array, and relatively low-speed user port in communication with the solid-state memory array, and wherein the programming port of the digital content kiosk is configured to mate with the relatively high-speed programming port of the memory device.

81. The digital content kiosk of claim 76 further comprising:
a connector configured to provide programming voltage to a memory device.

82. The digital content kiosk of claim 76 further comprising:
a cooling system configured to cool a memory device connected to the programming port.

83. The digital content kiosk of claim 76, wherein the user interface comprises a video touch screen.

84. The digital content kiosk of claim 76, wherein the user interface comprises a key pad.

85. The digital content kiosk of claim 76, wherein the transport mechanism comprises a movable carriage, a movable arm, and a movable pickup head.

86. The digital content kiosk of claim 76, wherein the solid-state memory array comprises a three-dimensional memory array comprising a plurality of memory cell layers stacked vertically above one another above a single silicon substrate.

87. The digital content kiosk of claim 76, wherein the solid-state memory array comprises a plurality of memory cells comprising a diode and a switchable-resistance material.

88. A digital content kiosk comprising:
a user interface operative to receive a selection of digital content from a user;
a first storage area storing a plurality of interim packages, each interim package comprising a respective solid-state memory array;
a second storage area storing a plurality of outer package shells shaped to be combined with the plurality of interim packages;
a programming port operative to program digital content into a solid-state memory array of an interim package;
a final package station operative to combine an interim package and an outer package shell to form a memory device in a final package; and
a transport mechanism operative to transport an interim package, an outer package shell, and a memory device in a final package in the digital content kiosk; and
circuitry operative to control operation of the user interface, programming port, final package station, and transport mechanism.

89. The digital content kiosk of claim 88 further comprising:
a label station operative to print a label.

90. The digital content kiosk of claim 88 further comprising:
a payment input device.

91. The digital content kiosk of claim 88 further comprising:
a connector operative to connect the digital content kiosk with a network.

92. The digital content kiosk of claim 88, wherein each interim package comprises a respective solid-state memory array, relatively high-speed programming port in communication with the solid-state memory array, and relatively low-speed user port in communication with the solid-state memory array, and wherein the programming port of the digital content kiosk is configured to mate with the relatively high-speed programming port of the interim package.

93. The digital content kiosk of claim 88 further comprising:
a connector configured to provide programming voltage to an interim package.

94. The digital content kiosk of claim 88 further comprising:
a cooling system configured to cool an interim package connected to the programming port.

95. The digital content kiosk of claim 88, wherein the user interface comprises a video touch screen.

96. The digital content kiosk of claim 88, wherein the user interface comprises a key pad.

97. The digital content kiosk of claim 88, wherein the transport mechanism comprises a movable carriage, a movable arm, and a movable pickup head.

98. The digital content kiosk of claim 88, wherein the solid-state memory array comprises a three-dimensional memory array comprising a plurality of memory cell layers stacked vertically above one another above a single silicon substrate.

99. The digital content kiosk of claim 88, wherein the solid-state memory array comprises a plurality of memory cells comprising a diode and a switchable-resistance material.

100. The digital content kiosk of claim 88, wherein the plurality of outer package shells comprises a plurality of different shapes.

101. A method for using a digital content kiosk to program digital content, the method comprising:
with a digital content kiosk:
receiving a selection of digital content;
establishing communication with a memory device comprising a solid-state memory array, a relatively high-speed programming port in communication with the solid-state memory array, and a relatively low-speed user port in communication with the solid-state memory array;
programming encrypted digital content in the memory device via the relatively high-speed programming port of the memory device; and
programming a key in the memory device, wherein the key is operative to decrypt the encrypted digital content.

102. The method of claim 101, wherein the key is programmed via the relatively high-speed programming port of the memory device.

103. The method of claim 101, wherein the key is programmed in the memory device using a secure channel.

104. The method of claim 101, wherein both the encrypted digital content and the key are programmed in the solid-state memory array.

105. The method of claim 101, wherein the memory device comprises a second solid-state memory array, wherein the encrypted digital content is programmed in the first-mentioned solid-state memory array, and wherein the key is programmed in the second solid-state memory array.

106. The method of claim 101 further comprising:
with the digital content kiosk, obtaining the memory device from a storage location in the digital content kiosk.

107. The method of claim 101 further comprising:
with the digital content kiosk, receiving the memory device from a user providing the selection of the digital content.

108. The method of claim 101, wherein the relatively high-speed programming port and the relatively low-speed user port are different physical ports on the memory device.

109. The method of claim 101, wherein the relatively high-speed programming port and the relatively low-speed user port are integrated in a dual-use port on the memory device.

110. The method of claim 101, wherein the solid-state memory array comprises a three-dimensional memory array comprising a plurality of memory cell layers stacked vertically above one another above a single silicon substrate.

111. The method of claim 101, wherein the solid-state memory array comprises a plurality of memory cells comprising a diode and a switchable-resistance material.

112. The method of claim 101 further comprising:
with the digital content kiosk, receiving the encrypted digital content via a network connection.

113. The method of claim 101 further comprising:
with the digital content kiosk, receiving the key via a network connection.

114. The method of claim 101, wherein the digital content kiosk stores a plurality of different-titled encrypted digital content and a plurality of keys, wherein there is one key for all encrypted digital content of the same title.

115. The method of claim 101, wherein the key comprises a content encryption key (CEK).

116. The method of claim 101, wherein the key is programmed in a secure storage location in the memory device.

117. The method of claim 101 further comprising, with the digital content kiosk, decrypting and re-encrypting digital content with a second key.

118. A method for using a digital content kiosk to program digital content, the method comprising:
sending digital content from a digital content kiosk to a memory device comprising a solid-state memory array;
with the memory device, encrypting the digital content using a content encryption key known to the memory device but not to the digital content kiosk;
storing the encrypted digital content in the memory device; and
establishing rights to the digital content for a user.

119. The method of claim 118, wherein the rights to the digital content for the user are established by the digital content kiosk.

120. The method of claim 118, wherein the rights to the digital content for the user are established by a device separate from the digital content kiosk.

121. The method of claim 120, wherein the device is located at a check-out counter.

122. The method of claim 120, wherein the device comprises a playback device.

123. The method of claim 118, wherein the encrypted digital content is stored in a restricted region in the memory device.

124. The method of claim 118, wherein the solid-state memory array comprises a three-dimensional memory array comprising a plurality of memory cell layers stacked vertically above one another above a single silicon substrate.

125. The method of claim 118, wherein the solid-state memory array comprises a plurality of memory cells comprising a diode and a switchable-resistance material.

126. A method for using a digital content kiosk to program digital content, the method comprising:
with a digital content kiosk:
receiving, from a user, a selection of digital content to be programmed in a memory device comprising a solid-state memory array;
determining whether the selected digital content will fit in the memory device;
if the selected digital content will fit in the memory device, programming the selected digital content in the memory device; and
if the selected digital content will not fit in the memory device, offering a programming option to the user.

127. The method of claim 126, wherein the programming option comprises removing at least one extra feature from the selected digital content.

128. The method of claim 126, wherein the programming option comprises offering the selected digital content at a lower quality.

129. The method of claim 126, wherein the programming option comprises offering the selected digital content in a compressed form.

130. The method of claim 126 further comprising:
with the digital content kiosk, obtaining the memory device from a storage location in the digital content kiosk.

131. The method of claim 126 further comprising:
with the digital content kiosk, receiving the memory device from a user providing the selection of the digital content.

132. The method of claim 126, wherein the memory device comprises a solid-state memory array, a relatively high-speed programming port in communication with the solid-state memory array, and a relatively low-speed user port in communication with the solid-state memory array.

133. The method of claim 132, wherein the relatively high-speed programming port and the relatively low-speed user port are different physical ports on the memory device.

134. The method of claim 132, wherein the relatively high-speed programming port and the relatively low-speed user port are integrated in a dual-use port on the memory device.

135. The method of claim 126, wherein the solid-state memory array comprises a three-dimensional memory array comprising a plurality of memory cell layers stacked vertically above one another above a single silicon substrate.

136. The method of claim 126, wherein the solid-state memory array comprises a plurality of memory cells comprising a diode and a switchable-resistance material.

137. The method of claim 126, wherein the memory device comprises an outer package shell.

138. The method of claim 126, wherein the memory device comprises an interim package.

139. A method for using a digital content kiosk to program digital content, the method comprising:
with a digital content kiosk:
receiving, from a user, a selection of digital content to be programmed in a memory device comprising a solid-state memory array;
determining whether there will be unused space in the memory device after the selected digital content is programmed in the memory device; and
if there will be unused space in the memory device after the selected digital content is programmed in the memory device, programming additional digital content in the memory device.

140. The method of claim 139 further comprising:
offering the additional digital content to the user, wherein the additional digital content is programmed in the memory device only if the user accepts the offer.

141. The method of claim 140 further comprising:
offering the user an incentive to accept the offer of the additional digital content.

142. The method of claim 139, wherein the additional digital content comprises a full-length movie.

143. The method of claim 139, wherein the additional digital content comprises a trailer.

144. The method of claim 139 further comprising:
with the digital content kiosk, obtaining the memory device from a storage location in the digital content kiosk.

145. The method of claim 139 further comprising:
with the digital content kiosk, receiving the memory device from a user providing the selection of the digital content.

146. The method of claim 139, wherein the memory device comprises a solid-state memory array, a relatively high-speed programming port in communication with the solid-state memory array, and a relatively low-speed user port in communication with the solid-state memory array.

147. The method of claim 139, wherein the solid-state memory array comprises a three-dimensional memory array comprising a plurality of memory cell layers stacked vertically above one another above a single silicon substrate.

148. The method of claim 139, wherein the solid-state memory array comprises a plurality of memory cells comprising a diode and a switchable-resistance material.

149. The method of claim 139, wherein the memory device comprises an outer package shell.

150. The method of claim 139, wherein the memory device comprises an interim package.

151. A method for using a digital content kiosk to program digital content, the method comprising:
with a digital content kiosk:
receiving, from a user, a selection of digital content to be programmed in a memory device comprising a solid-state memory array;
attempting to program the selected digital content in the memory device;
determining that a programming failure occurred, wherein, after the programming failure, some unused space remains in the memory device; and
offering the user alternate digital content to be programmed in the unused space.

152. The method of claim 151, wherein the alternate digital content comprises a lower-quality version of the selected digital content.

153. The method of claim 151, wherein the alternate digital content comprises the selected digital content in a compressed form.

154. The method of claim 151, wherein the alternate digital content comprises the selected digital content with at least one extra feature removed.

155. The method of claim 151, wherein the memory device comprises a solid-state memory array, a relatively high-speed programming port in communication with the solid-state memory array, and a relatively low-speed user port in communication with the solid-state memory array.

156. The method of claim 155, wherein the relatively high-speed programming port and the relatively low-speed user port are different physical ports on the memory device.

157. The method of claim 155, wherein the relatively high-speed programming port and the relatively low-speed user port are integrated in a dual-use port on the memory device.

158. The method of claim 151, wherein the solid-state memory array comprises a three-dimensional memory array comprising a plurality of memory cell layers stacked vertically above one another above a single silicon substrate.

159. The method of claim 151, wherein the solid-state memory array comprises a plurality of memory cells comprising a diode and a switchable-resistance material.

160. The method of claim 151, wherein the memory device comprises an outer package shell.

161. The method of claim 151, wherein the memory device comprises an interim package.

162. The method of claim 151 further comprising:
with the digital content kiosk, obtaining the memory device from a storage location in the digital content kiosk.

163. The method of claim 151 further comprising:
with the digital content kiosk, receiving the memory device from a user providing the selection of the digital content.

164. The method of claim 151 further comprising:
storing the memory device in the digital content kiosk for later use if the user declines the offer of alternate digital content.

165. A method for using a digital content kiosk to program digital content, the method comprising:
with a digital content kiosk:
attempting to program a memory device comprising a solid-state memory array;
in response to an error in programming the memory device, storing the memory device in a recycling area in the digital content kiosk;
receiving, from a user, a selection of digital content;
retrieving the memory device from the recycling area; and
programming the selected digital content in the memory device.

166. The method of claim 165, wherein the memory device comprises a solid-state memory array, a relatively high-speed programming port in communication with the solid-state memory array, and a relatively low-speed user port in communication with the solid-state memory array.

167. The method of claim 166, wherein the relatively high-speed programming port and the relatively low-speed user port are different physical ports on the memory device.

168. The method of claim 166, wherein the relatively high-speed programming port and the relatively low-speed user port are integrated in a dual-use port on the memory device.

169. The method of claim 165, wherein the solid-state memory array comprises a three-dimensional memory array comprising a plurality of memory cell layers stacked vertically above one another above a single silicon substrate.

170. The method of claim 165, wherein the solid-state memory array comprises a plurality of memory cells comprising a diode and a switchable-resistance material.

171. The method of claim 165, wherein the memory device comprises an outer package shell.

172. The method of claim 165, wherein the memory device comprises an interim package.

173. The method of claim 165 further comprising:
with the digital content kiosk, obtaining the user's permission to use the memory device from the recycled area.

174. The method of claim 165 further comprising:
with the digital content kiosk, providing the user with an incentive to use the memory device from the recycled area.

175. The method of claim 165 further comprising:
with the digital content kiosk, storing a designation of a partially-programmed state in the memory device.
